(19) United States
(12) Patent Application Publication
(10) Pub. No.: US 2023/0280559 A1
(43) Pub. Date: Sep. 7, 2023

(54) FIBRE OPTIC CABLE, METHODS OF MANUFACTURE AND USE THEREOF

(71) Applicant: EMTELLE UK LIMITED, Hawick (GB)

(72) Inventors: William George RAE, Hawick (GB); Jonathan Paul TAYLOR, Hawick (GB); Eben Colin KIRKPATRICK, Hawick (GB); Jamie Ross MCGEE, Hawick (GB)

(73) Assignee: EMTELLE UK LIMITED, Hawick (GB)

(21) Appl. No.: 18/024,326

(22) PCT Filed: Aug. 31, 2021
(86) PCT No.: PCT/EP2021/073976

§ 371 Date: Mar. 2, 2023

(30) Foreign Application Priority Data
Sep. 3, 2020 (GB) 2013892.1
Aug. 12, 2021 (GB) 2111598.5

(51) Int. Cl. G02B 6/44; C03C 25/18; C03C 25/323; C03C 25/40; C03C 25/285; C03C 25/30; C09D 167/02; C08L 67/02

(52) U.S. Cl. CPC G02B 6/443; G02B 6/4438; G02B 6/4486; C03C 25/18; C03C 25/323; C03C 25/40; C03C 25/285; C03C 25/30; C09D 167/02; C08L 67/02

(57) ABSTRACT

A fibre optic cable (500, 700, 1420) comprises one or more fibre units (502, 1302). Each fibre unit comprises two or more optical fibres (506, 1306) embedded in a solid resin material (520, 1320) to form a coated fibre bundle and an extruded polymer sheath (524, 1324). The sheath (524, 1324) of each fibre unit is primarily polybutylene terephthalate (PBT), with a friction reducing additive such as polydimethylsiloxane (PDMS). The additive may be polythene based and/or polyacrylate based. The fibre unit may be applied in a pullback cable (500, 800, 1100), as a cable for pulling or pushing or as a blown fibre cable (502, 1302).

### FIELD OF THE INVENTION

The present invention relates to fibre units for use in fibre optic cables. A single fibre unit may be used as a fibre optic cable, for example adapted for installation in a duct by blowing. A plurality of fibre units may be formed into a larger cable. The invention further relates to methods of manufacturing such cables and methods of installation thereof. Such cables allow a selected fibre unit to be retracted from a section of the cable, and rerouted to an individual user without the need to create a splice joint.

### BACKGROUND TO THE INVENTION

Optical fibre transmission lines can be installed through the ground, through ducts, and through service spaces within buildings by a variety of methods, including direct burying (trenching), pulling through ducts, pushing through ducts, blowing through ducts, and combinations of these. Fibre to the home (FTTH) is the generic term for broadband network architecture that uses optical fibre technology to carry data to a residential dwelling from a broadband service provider via a telecommunications cabinet located near the residential dwelling. More generally, not only homes, but office premises are increasingly connected by optical fibres to the wider telecommunications network.

One type of optical fibre cable is a blown fibre unit of the type disclosed in published international patent application WO2004015475A2. The known blown fibre unit comprises two or more optical fibres embedded in a solid resin material to form a coated fibre bundle covered by an extruded polymer sheath of low-friction high-density polyethylene (HDPE). Such fibre units have been designed, and used for many years, for installation by blowing with air or other compressed fluid. Fibre units of this type are known to blow hundreds and even thousands of metres, in micro-ducts having a compatible low-friction high-density polyethylene (HDPE) lining. However, they can also be installed by pulling and/or pushing, depending on the distance and the route involved.

The known blown fibre unit has been commercially very successful, extending fibre optic communications in a cost-effective manner to streets and homes, as well as commercial premises. Aside from the cost of the product itself, the speed and ease of installation become ever more important. Various enhancements to the form of the sheath, and modifications of the HDPE material have been applied to increase performance under a wide range of use cases and environmental conditions.

Another type of cable is known, which comprises multiple fibre units contained loosely within an extruded tube. Once installed in the ground, or on or within a building, the extruded tube can be opened at any point along its length to access the individual fibre units, which extend loosely inside. A selected fibre unit can be accessed, retracted, and rerouted to drop directly to a home / business where fibre provision is required. Several commercial cables of this type are available, including one branded RTRYVA™ from the present applicant. They may be referred to as “pullback cable”, “retractable fibre cable”, or “mid span”/“mid span access” cable, depending on the manufacturer and user preference. The term “pullback cable” will be used in the following description, as a convenient term for this type of product, and with the existing RTRYVA™ product as a specific known example. Pullback cable offers a number of advantages over traditional cabling solutions because several times more fibre drops can be made from an existing duct compared to traditional cables. Fibre units within pullback cable can contain multiple fibres, varying from 2 to 12 fibres per fibre unit. High speed installation and connectivity can be attained with no specialist training, and without breaking or splicing the fibres, where they branch from the pullback cable to the customer premises. GRP strength members are incorporated in the extruded tube to offer additional strength and longevity, without the need for bulky strength members in the individual fibre units.

Drop tubes can have a pre-installed draw string to aid fibre installation to the home. Expensive installation equipment, such as fibre blowing is not required.

Despite these benefits of pullback cable, the use is restricted, or made inefficient, by the limited length of fibre unit that can be withdrawn in one section. Where the premises is located more than a few tens of metres from the route of the pullback cable, steps of withdrawing the selected fibre unit, and redirecting it to the customer premises, must be performed in multiple stages, opening the extruded tube within the ground or other environment several times, and repositioning operatives several times to reach customer premises in stages.

Accordingly, the inventors have recognised that, in many situations, the potential benefits of pullback cabling are not realised. The inventors have further recognised that the length of fibre unit withdrawn or installed in one step is limited by the materials and loose tube construction of the fibre units in a conventional pullback cable. Unfortunately, the use of other types of fibre unit, such as fibre units with low friction HDPE sheaths, that are known for installation by blowing, cannot readily be substituted into known types of pullback cables, due to the manufacturing process.

### SUMMARY OF THE INVENTION

A first aspect of the present invention provides a fibre optic cable comprising at least one fibre unit, wherein said fibre unit comprises two or more optical fibres embedded in a solid resin material to form a coated fibre bundle and an extruded polymer sheath covering the coated fibre bundle, wherein the extruded polymer sheath of each said fibre unit comprises a mixture of polybutylene terephthalate polymer (PBT) and at least one friction reducing additive.

The PBT polymer excluding additives may comprise at least 95% by weight, at least 90% by weight or at least 80% by weight of the extruded sheath.

Embodiments of the invention are disclosed in which the friction reducing additive comprises a polydimethylsiloxane material, PDMS, in a carrier material. These materials are available for example from Dow Corning in the form of masterbatch additives for blending with the base polymer of the sheath in an extrusion machine.

The amount of friction reducing additive may be between 1% and 5%, optionally between 2% and 4% by weight of the material of the extruded sheath.

In some examples, said PDMS is an ultra-high molecular weight PDMS and said carrier material is a polyacrylate material, for example a copolymer of ethylene and methyl acrylate, EMA.

In other examples, said PDMS is an ultra-high molecular weight PDMS and said carrier material is a polyolefin, such as low-density polyethylene (LPDE). The additive may comprise at least 40%, for example 50% by weight ultra-high molecular weight PDMS dispersed in said low-density polyethylene (LPDE).

The inventors have found that between 2% and 4%, more particularly between 2.5 and 3.5% of a commercially available LDPE-based PDMS additive affords a substantial reduction in friction, with no attendant problems in extrusion. This performance was apparently better than using a polyacrylate based additive specifically marketed for blending with PBT. The overall siloxane content of the sheath material may be at least 1%, for example 1.5% or more (including any friction reducing material that is blended already with the PBT base polymer in a commercial product).

The solid resin material may comprise a UV-cured resin such as an acrylate material.

The solid resin material may have a tensile modulus greater than 100 MPa, optionally in the range 250-700 MPa, optionally around 300 MPa.

The invention further provides a fibre optic cable comprising a plurality of said fibre units extending in parallel with one another and being arranged within an extruded polymer tube, the fibre units being free to slide relative to one another and relative to the tube such that a selected fibre unit can be accessed and re-directed by forming an opening in a wall of the tube and withdrawing a length of the selected fibre unit through the opening.

The inventors have recognised that the known blown fibre unit having a low-friction PE sheath, if it were to be used as a fibre unit in a pullback cable, might greatly extend the range of distances that can be covered by a single withdrawal and installation step. If such a known fibre unit were to be used in the existing extruded tube, however, it is not likely to survive the manufacturing process of the pullback cable, without fusing at some point to the hot extruded tube. The inventors have recognised that, by changing the sheath material applied over the resin-coated fibre bundle to be based on PBT polymer instead of PE, the benefits of the fibre unit with resin core may be obtained to some extent, while avoiding the problem of fusing to the hot extruded tube. Reasons for this may include the dissimilar chemical and crystalline character of the materials, as well as the higher melting point of PBT compared with the extruded PE. In such an embodiment, the thickness of the PBT sheath on each fibre unit may be between 0.05 mm and 0.25 mm, optionally between 0.15 mm and 0.25 mm.

In some embodiments, an inner surface of the extruded polymer tube of the fibre optic cable is formed with projections that are effective to reduce an area of contact between material of the tube and the fibre units. The projections may be extruded in the form of longitudinal ribs.

The extruded polymer tube may be extruded with one or more strength members integrated in a wall of the tube during extrusion.

The lining of the extruded polymer tube may comprise primarily polyethylene, typically HDPE. This may for example be the same material as in the known pullback cable, while the choice of PBT for the fibre unit sheath allows manufacture of the pullback cable without fusing.

The lining of the extruded polymer tube may further comprise one or more additives including a friction reducing material.

The extruded polymer tube may comprise a co-extrusion of said lining material within a main tubular body of a different polymer to the lining. The main tubular body may be of polyethylene. The main tubular body may be extruded of medium density polyethylene MDPE.

The extruded polymer tube may be extruded with one or more strength members integrated in a main wall of the tube during extrusion.

The strength member may be a fibre-reinforced resin rod.

The extruded polymer tube may be further provided with external markings by which a user can avoid the strength member(s) when making said opening.

The extruded sheath of each of said fibre units may be provided with colour and/or other markings by which a selected fibre unit is distinguishable from all the other fibre units in the tube.

Performance of pullback cables according to the present invention can be verified by one or more of the following tests.

When said fibre optic cable is laid out in a generally straight route, a length of 100 m of a selected fibre unit may be withdrawn through an opening in the extruded tube at a speed greater than 1.4 m/s, without a pulling force exceeding the weight of a mass W, defined as the mass per kilometre length of the selected fibre unit.

A length of 100 m of a selected fibre unit may be withdrawn through an opening in the extruded tube at a speed of 1.4 m/s, without a pulling force exceeding a specified fraction of the weight of said mass W, for example 3W/4 or W/2 or W/3.

When said fibre optic cable is laid out in a generally straight route, a length of 100 m of a selected fibre unit may reliably be withdrawn through an opening in the extruded tube at a speed of 1.4 m/s, without a pulling force exceeding 5 N multiplied by the number of optical fibres in the selected fibre unit.

When said fibre optic cable is laid out in a generally straight route, said length of 100 m of a selected fibre unit may reliably be withdrawn through an opening in the extruded tube at a speed of 1.4 m/s, without a pulling force exceeding 2.5 N multiplied by the number of optical fibres in the selected fibre unit.

When said fibre optic cable is laid out in a generally straight route, a length of 200 m of a selected fibre unit may reliably be withdrawn through an opening in the extruded tube at a speed of 1.4 m/s, without a pulling force exceeding 5 N multiplied by the number of optical fibres in the selected fibre unit.

A coefficient of friction μ between the sheath of one of said fibre units and the lining of the extruded tube may be 0.2 or less, when measured by a capstan friction test of the general type described herein and illustrated in FIG. 8 of the drawings.

A coefficient of friction μ between the sheaths of said fibre units may be 0.2 or less, when measured by a capstan friction test of the general type described herein and illustrated in FIG. 9 of the drawings.

The invention in the first aspect further provides a fibre optic cable comprising a single fibre unit whose outermost layer is said PBT sheath, and which is adapted to be installed in a duct by blowing.

The inventors have found that a fibre unit with very good blowing performance and mechanical properties can be achieved by changing the low friction HDPE sheath of the known blown fibre unit for a sheath made of PBT with friction reducing additive. With additives of the type mentioned above, blowing performance exceeding that of the known blown fibre unit has been obtained in tests. The PBT sheath material is substantially harder and stronger than the HDPE material, and can be made thinner than the known HDPE sheath, if desired.

In one such embodiment, the thickness of the PBT sheath on the fibre unit is between 0.05 mm and 0.2 mm, optionally between 0.08 mm and 0.15 mm, optionally less than 0.130 mm.

In some embodiments, the number of optical fibres including any mechanical fibre is up to four and an outer diameter (OD) of the fibre unit is less than 1.2 mm, optionally less than 1.1 mm. The OD may increase with the number of fibres, for example so that fibre units having up to 6, 8, 12 or 24 fibres may have OD less than 1.3, 1.5, 1.6 and 2.1 mm, respectively.

In other embodiments, said fibre optic cable is further adapted to be installed by pushing as well as by blowing, and an outer diameter of the fibre unit is in the range of 1.5 to 2.5 mm, for example in the range 1.9 to 2.2 millimetres, for example 2.0 to 2.1 mm. In some such examples, said coated fibre bundle includes one or more strength members, for example an FRP strength member, embedded together with said optical fibres within said resin material.

In some embodiments, at least one of said optical fibres is terminated at at least one end with a blowable optical ferrule prior to installation in a duct.

Pullback cables and blown fibre units are only some examples of the applications of the invention in the first aspect. A fibre unit with a slightly thicker PBT sheath may be adapted for use as a cable for pushing and/or pulling installation methods.

The invention in a second aspect provides a method of manufacturing a fibre unit for use as a fibre optic cable or for use in the manufacture of a fibre optic cable, the method comprising:
(a) receiving a coated fibre bundle comprising two or more optical fibres embedded in a solid resin material; and
(b) extruding a polymer sheath covering the coated fibre bundle, the extruded polymer sheath comprising a mixture of polybutylene terephthalate, PBT polymer and at least one friction reducing additive.

Features of the first aspect may equally apply to this further aspect of the invention. For example, a lining of the extruded polymer tube may comprise primarily polyethylene, typically HDPE. For example, the coated fibre bundle may include one or more strength members embedded together with the optical fibres.

There is also provided a method of manufacturing a fibre optic cable comprising a plurality of fibre units extending in parallel with one another within an extruded polymer tube, the method comprising:
(c) receiving a plurality of fibre units, each fibre unit having been manufactured by the method of the second aspect of the invention as set forth above;
(d) feeding said plurality of fibre units together as a bundle through a central opening in an extrusion die, while extruding said polymer tube through said die around the bundle;
(e) drawing said polymer tube and bundle through the extrusion die while controlling process parameters to draw and cool the polymer tube to have finished interior and exterior dimensions such that the fibre units remain loose within the extruded tube,
thereby producing said fibre optic cable such that a selected fibre unit can be accessed and re-directed by forming an opening in a wall of the tube and withdrawing a length of the selected fibre unit through the opening.

The lining of the extruded polymer tube may further comprise one or more additives including a friction reducing material.

The extruded sheath of each said fibre unit may comprise a mixture of PBT polymer and one or more additives including a friction reducing material. The friction reducing material may be additional to friction reducing material included in a commercial PBT grade.

The solid resin material may comprise a UV-cured resin such as an acrylate material.

The solid resin material may have a tensile modulus greater than 100 MPa, optionally greater than 300 MPa.

In step (d) the extruded tube may be formed by co-extrusion of said lining material within a main tubular body of a different polymer to the lining.

The lining of the extruded polymer tube may for example comprise primarily polyethylene, HDPE.

The lining of the extruded polymer tube may further comprise one or more additives including a friction reducing material.

The main tubular body may be of polyethylene.

The main tubular body may be extruded of medium density polyethylene MDPE.

In step (b) said extruded tube may be extruded with one or more strength members integrated therein.

The strength member may be a fibre-reinforced resin rod.

In step (b) said extruded tube may be further co-extruded with stripes by which a user can identify the circumferential location(s) of the strength member(s) when making said opening.

The extruded sheath of each of said fibre units may be provided with colour and/or other markings by which a selected fibre unit is distinguishable from all the other fibre units in the tube.

A vacuum tank may be provided downstream of said extrusion die to control shrinkage of the extruded tube during initial cooling.

These and other features of the invention will be understood from consideration of the examples described below and the dependent claims, illustrated with the appended drawings.

### BRIEF DESCRIPTION OF THE DRAWINGS

Embodiments of the present invention are described below, by way of example only, with reference to the accompanying drawings, in which:

FIG. 1 is a cross-section of a known pullback cable comprising a number of loose tube fibre units surrounded by an extruded, reinforced tube;

FIG. 2 illustrates the steps of opening a wall of the extruded tube and pulling back a selected fibre unit in a pullback cable of the type shown in FIG. 1;

FIG. 3 illustrates use of a pullback cable to provide optical fibre connections to user premises according to a known method;

FIG. 4 illustrates problems arising in the known method, when a distance from the pullback cable to the user premises exceeds a pullback distance of the selected fibre unit;

FIG. 5 is a schematic cross-section (a) of a pullback cable according to an embodiment of the present invention, including enlarged detail (b) of a single fibre unit in contact with a lining of the extruded tube;

FIG. 6 is a schematic illustration of the manufacturing process of the pullback cable of FIG. 5;

FIG. 7 illustrates (a) a test procedure for measuring pull-out force in the evaluation of pullback cables of the prior art and the invention, (b) test results for a pullback cable according to an embodiment of the present invention, and (c) test results for a known pullback cable of the type illustrated in FIG. 1;

FIG. 8 illustrates a first friction test for evaluation of a pullback cable;

FIG. 9 illustrates a second friction test for evaluation of a pullback cable;

FIG. 10 illustrates application of a pullback cable as a riser cable in a multi-story building;

FIG. 11 is a cross-section of a modified pullback cable according to another embodiment of the invention;

FIG. 12 is a schematic cross-section of a modified fibre unit usable for example in the pullback cable of FIG. 5 or FIG. 11;

FIG. 13 is a schematic cross section of ((a) and (b)) further examples of a fibre unit usable for example in the pullback cables, and (c) an example fibre unit according to the invention, optimised for installation by blowing;

FIG. 14 is a schematic representation of a method of installing Fibre to the Home (FTTH), which includes installing a pre-terminated optical fibre unit made according to an embodiment of the present invention;

FIG. 15 is a schematic representation of a blowing process, as an example of how to install a pre-terminated optical fibre construction according to an embodiment of the present invention between a home location and a transmission/supply location;

FIG. 16 shows a pulling accessory usable with a fibre cable assembly pre-terminated at one or both ends;

FIG. 17 illustrates a third friction test being used for evaluation of a blown fibre cable;

FIG. 18 illustrates a blowing test route used in blowing performance tests experiments; and

FIG. 19 is a schematic cross section of a further example fibre optic cable according to an embodiment of the present invention, optimised for installation by pushing as well as blowing.

### DETAILED DESCRIPTION OF EXEMPLARY EMBODIMENTS

As mentioned in the introduction, the present application discloses a particular form and material composition of a fibre unit, and different types of fibre optic cable in which such fibre units may be applied. The fibre unit comprises two or more optical fibres embedded in a solid resin material to form a coated fibre bundle and an extruded polymer sheath covering the coated fibre bundle, wherein the extruded polymer sheath of each said fibre unit comprises a mixture of polybutylene terephthalate polymer, PBT, and at least one friction reducing additive. Purely by way of example, locations of this fibre unit will be described, including a pullback cable. The fibre unit, either singly or in combination with other fibre units, can be applied in a variety of other cable types, where its properties of robustness and low surface friction may be beneficial.

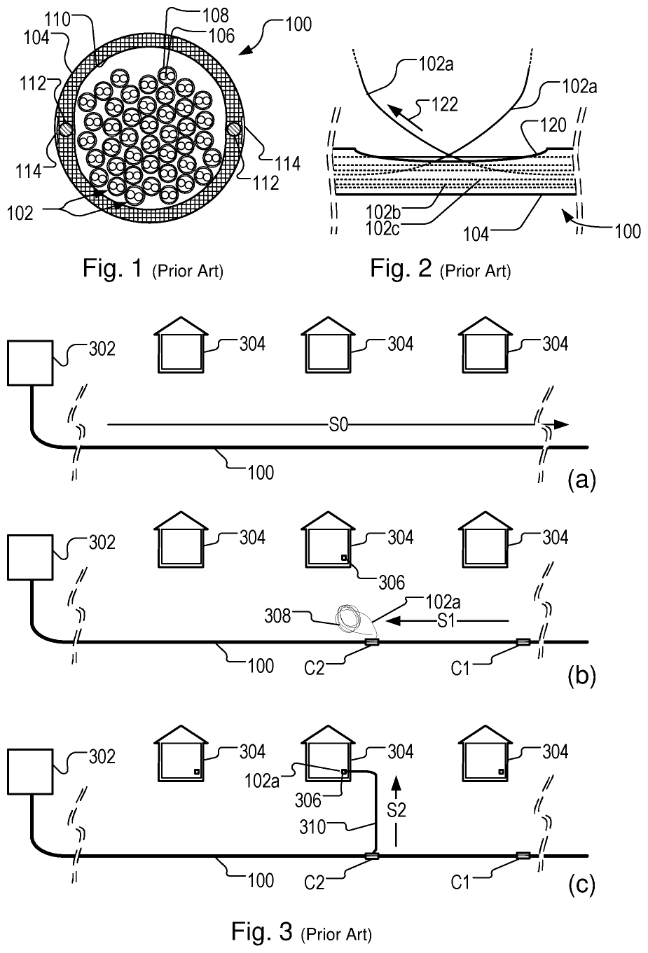

FIG. 1 is a schematic cross-section of a known pullback cable 100. Different manufacturers currently provide pullback cables containing optical fibres. An example is that marketed by the present applicant under the trade name RTRYVA™. The cable 100 in this example comprises a plurality of fibre units 102 extending in parallel with one another within an extruded polymer tube 104. The fibre units 102 are free to slide relative to one another and to the tube 104 such that a selected fibre unit 102 can be accessed and re-directed by forming an opening in a wall of the tube 104 and withdrawing a length of the selected fibre unit 102 through the opening.

FIG. 2 illustrates this opening and pullback operation. An opening 120 is formed in the wall of the extruded tube 104 by cutting with a blade, which may be mounted in a special tool in a known manner. One individual fibre unit 102a is selected, for example by colour code, and pulled in a direction 122 from inside the extruded tube 104. Other fibre units 102b and 102c remain within the tube 104. The application of this will be described further below, with reference to FIG. 3.

Returning to the construction of the pullback cable 100, shown in FIGS. 1 and 2, each fibre unit 102 comprises a number of optical fibres 106 contained within an extruded polymer unit tube 108. The unit tube 108, in the known products, is made of polybutylene terephthalate (PBT). PBT is a thermoplastic engineering polymer often used as an insulator in the electrical and electronics industries. It is a type of polyester, which may be provided with additives to improve properties such as UV resistance and flammability. Other makes of pullback cable known commercially use PVC instead of PBT, in a form which contains plasticisers and fillers, so as to be easily torn.

In contrast to the products disclosed herein, the fibre units 102 of known pullback cables have a conventional “loose tube” design, so that the fibres 106 within each unit tube 108 are also free to slide, the unit tube 108 being filled by a compound such as a water-blocking gel. The optical fibres 106 are generally so-called primary coated optical fibres, in which the glass core and glass cladding layers are coated with layers of resin immediately upon formation, to provide buffering and to protect the surface against damage. The number of optical fibres 106 within each unit tube 108 may vary, for example ranging from 2 to 12. All of the fibre units 102 in the illustrated example comprise two optical fibres 106, but some or all of the fibre units 102 in another example product may contain four fibres, or a different number. The number of fibres 102 within each fibre unit 102 may vary between products, and even within the same product, some tubes 108 may contain different numbers of fibres 106, to provide flexibility of application.

Similarly, the number of fibre units in the pullback cable, and hence the number of optical fibres, may vary, with typical numbers being 12, 24 or 48 fibre units. Higher numbers such as 96 fibre units are possible if desired. To produce the fibre units 102, the appropriate number of primary-coated optical fibres 106, each with appropriate colour coding, are passed through an extrusion die, which forms the unit tube 108 around the optical fibres. The different fibre units 102 are made with different colours of extruded unit tube 108, so that they may be identified in the finished pullback cable. Then, to produce the pullback cable 100, the appropriate number of fibre units 102 are bundled together and passed through an extrusion die which forms the extruded tube 104. Depending on whether the cable 100 is for exterior or interior use, the polymer of the extruded tube 104 may vary. In an example for exterior use, polyethylene, for example high-density polyethylene (HDPE) or medium-density polyethylene (MDPE) may be selected. An inner surface 110 of the tube wall may be coated with a low friction coating. In some known examples, a thin lining of HDPE with friction reducing additives (slip agents) and antistatic additives is used to form a thin lining, by coextrusion with a main body of the wall. For interior use (within premises) the polyethylene of the tube main body may be substituted by a flame resistant, zero halogen polymer, as is well known.

Also included in the wall of the extruded tube are strength members 112, typically glass fibre reinforced plastic (GFRP, FRP or GRP for short) rods, and typically at diametrically opposite positions on the circumference of the tube 104. The tube wall is provided with stripes or other external markings 114, so that the locations of the strength members 112 can be identified. This allows the strength members to be avoided when making the opening 120. In a known example, stripes of different coloured polymer are co-extruded with the main wall body to provide the external markings 114.

Referring now to FIG. 3, pullback cables 100 have been developed as a quick and easy solution for connecting homes and businesses to a fibre optic communications network. Within the extruded tube of the pullback cable 100, multiple loose fibres are installed during manufacture. Once the pullback cable 100 is installed, duct access & branching of individual fibre units from the pullback cable 100 to individual customer access points is quick and easy and uses the minimal tools, training and installation equipment. Fibres are accessed, excess fibre is pulled back out of the duct, then branched to the customer premises through a dedicated drop duct. Fibre installation to inside the home/business is carried out by pushing or pulling.

Referring to FIG. 3(a), a length of pullback cable 100 is installed, over a route extending from a distribution point 302, such as a splicing cabinet, and passing a number of customer premises 304. In a step S0, the pullback cable 100 is pulled into a duct, or installed into an open trench along the desired route. (In multi-storey premises, the cable may be fixed into a vertical riser shaft). In the splice cabinet or other distribution point 302 the fibres are fixed in place and can be spliced at once if required, or left un-terminated, until one by one they are required.

Referring then to FIG. 3(b), suppose it is desired to make a fibre connection to the middle premises 304, which is provided with a customer access point 306. In a step S1, a cutting tool is used to cut the extruded tube 104 (as illustrated in FIG. 2) to create openings C1 and C2 as shown. Care is taken to avoid the strength members 112, by reference to the stripes or other external markings 114. At the opening C1, which is at a location beyond opening C2 a selected fibre (call it 102a, the same as in FIG. 2) is identified within the open tube 104, and cut, to free its end. Then, at opening C2, the section of selected fibre unit 102a is withdrawn from the tube 104 into a coil as shown at 308. Although the coil 308 is shown loose, it will be understood that in practice it will be safely gathered in a pan or on a reel. The position of the opening C2, and the length of the withdrawn section, are such that the withdrawn section is long enough to reach the customer access point 306.

Referring then to FIG. 3(c) in a step S2, a branching duct 310 is installed from the opening C2 to the customer access point 306, and the withdrawn section of the selected fibre unit 102a is fed through the duct until it emerges at the customer access point 306 as marked. For short distances, pushing may be an adequate installation method. In other cases, pulling may be used, for example using a pulling line that has been pre-installed in the branching duct 310. It will be understood that, as an alternative to installing the branching ducts 310 only at the time of need, branching ducts can be pre-installed for all the customer premises 304. At each opening C1, C2, not shown or described in detail, an enclosure having suitable seals and openings, is provided to protect the opening, and the exposed ends of the branching duct or ducts, against the environment after installation. More than one branching duct can be accommodated in a typical enclosure. The enclosures may be the same as conventional splicing enclosures, while it may be noted that the use of the pullback cable 100 provides for branching without the need to make cuts and splices of the optical fibres at the branch location. The fibre unit 102a is continuous from the distribution point 302 to the customer access point 306.

Because the strength members 112 are provided in the extruded tube 104, and there are no separate strength members in the fibre units 102, the overall design can be very compact, compared with what would be required to accommodate the same number of fibre units as individual cables. The diameter of the extruded tube, and hence the overall diameter of the pullback cable itself, may be on the order of 15 to 20 mm. For example, the cable size may be designated 15/9, meaning an outer diameter of 15 mm combined with an inner diameter of 9 mm. Note that the bore of the tube 104 is slightly oval, so that the strength members 112 and stripes 114 can be accommodated in thicker portions of the wall.

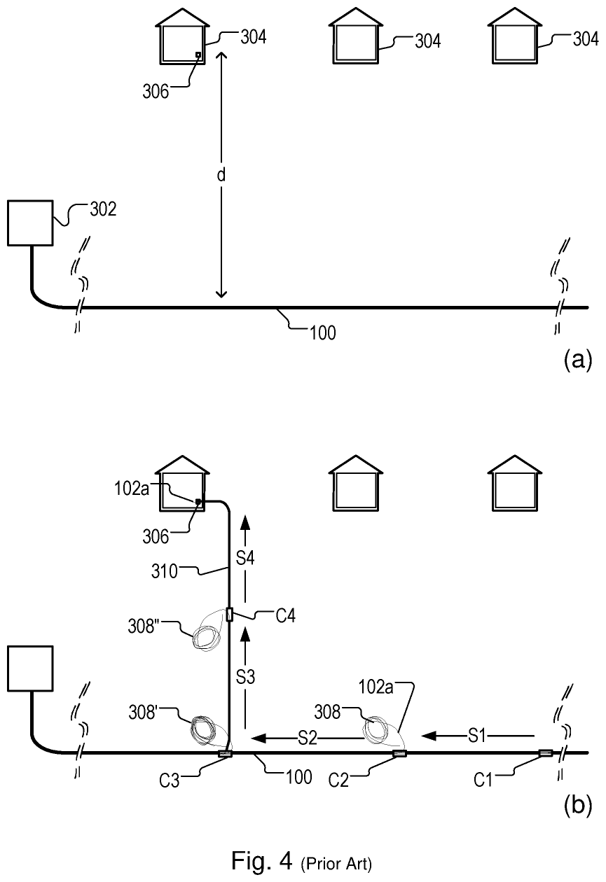

Referring now to FIG. 4, a limitation of the known pullback cables is that the selected fibre units can only be pulled back in sections of limited length, without exceeding tensile performance limits of the products. So, in the example of a fibre unit 102 having two optical fibres in a known pullback cable, a pulling force in excess of 1.5 kg (15 N) is sufficient to damage the fibre unit 102 by stretching the PBT unit tube 104. This causes the PBT polymer to “neck down” on the optical fibres, exposing the branch to unacceptable optical losses. In addition, forces greater than 1.5 kg are liable to snap individual fibres within the unit tube 104. The degree of pulling force required to withdraw a section of unit tube 104 depends strongly on the length of the section, as well as its friction against the other fibre units and the inner wall of the tube 104. In practice these forces limit the length of unit tube 104 that can be withdrawn to about 30 m, or 50 m maximum. Similarly, the properties of the fibre units 102, being of loose tube design do not allow great lengths to be pushed, pulled or blown over a great distance through a branching duct 310. Moreover, even these limited distances may be obtained only in a generally straight route. A lesser distance may be available if the route of the pullback cable 100 is in any way convoluted by bends.

In the situation shown at FIG. 4(a), a distance d between the route of the pullback cable 100 and the access point at a premises 304 to be connected to the optical fibre network is greater than the maximum pullback distance, and/or the maximum distance that can be installed through a branching duct 310. This is a common situation with the known products. The conventional solution, as shown in FIG. 4(b), is to perform the withdrawal and/or branch installation in multiple stages. Multiple openings C1, C2, C3, are provided in the wall of the pullback cable 100. Similarly, an intermediate opening C4 is provided in the branching duct 310. Using these openings, and more intermediate openings if required, withdrawal of the selected fibre unit is performed in the following steps: a step S1 to withdraw a length of 30 m and gather in a first coil shown at 308; a step S2 to withdraw another length of 30 or so metres followed by the length already withdrawn in step S1, and gather in a larger second coil shown at 308′.

Similarly, re-installation of the selected fibre unit into the branching duct 310 is performed in the following steps: step S3 to install the selected fibre unit from opening C3 along a first section of the branching duct 310 and gather it in a third coil shown at 308″ via opening C4; step S4 installing the remaining length from the coil shown at 308″ through the last section of the branching duct 310 to the customer access point 306. It will be appreciated that the effort in the operation, and the risk of damaging fibres and fibre units in the process, is doubled. Moreover, when one considers that customer drops of 200 or 300 m are commonplace, and 500 m is not unknown, the number of intermediate openings and withdrawal steps can become very great indeed. The practical and economic benefits of the pullback cable concept become reduced, and eventually lost completely.

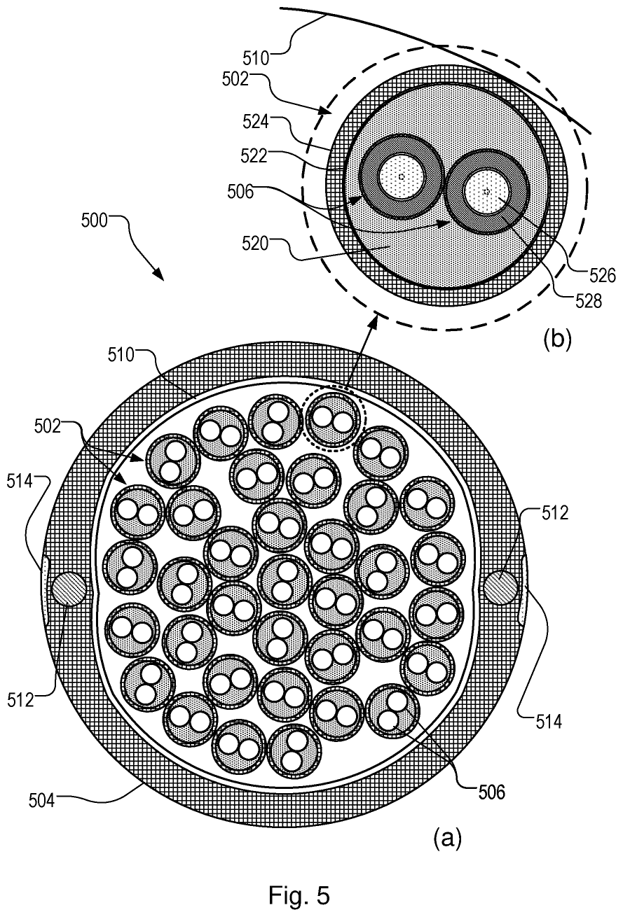

FIG. 5 shows (a) a cross-section of a modified pullback cable 500 according to an embodiment of the present invention, and (b) enlarged detail of a single fibre unit 502. The cable 500 in this example comprises a plurality of fibre units 502 extending in parallel with one another within an extruded polymer tube 504. Each fibre unit 502 includes a plurality of individual optical fibres 506. As in the known pullback cable 100 the fibre units 502 are free to slide relative to one another and to the tube 504 such that a selected fibre unit 502 can be accessed and re-directed by forming an opening in a wall of the tube 504 and withdrawing a length of the selected fibre unit through the opening. Similar to the known pullback cable 100, the modified pullback cable 500 includes strength members 512 integrated in the wall of the extruded tube 504. These strength members are, for example glass fibre reinforced plastic (GFRP, FRP or GRP for short) rods, and positioned at diametrically opposite positions on the circumference of the tube 504. The form and number of strength members 512 can be varied, to suit the application. Metallic strength members can be incorporated, if desired, although for many applications it will be regarded as a benefit for the construction to be metal-free.

The tube wall is provided with stripes or other external markings 514, so that the locations of the strength members 512 can be identified. This allows the strength members 512 to be avoided when making an opening. In the illustrated example, stripes of different coloured polymer are co-extruded with the main wall body to provide the external markings 514. Other means of providing external markings 514 can be used.

The optical fibres 506 are again so-called primary coated optical fibres, in which a glass body 526 (typically comprising a core and cladding layer, or a graded index core) is coated with two or three layers of resin 528, to provide buffering and to protect the surface against damage. The diameter of the glass core is commonly on the order of 100 μm, for example 125 μm. The diameter of the primary coated optical fibre 506 is typically 250 μm.

The modified pullback cable 500 differs from the known cable 100 in that the individual fibre units 502 are no longer in the form of a loose tube of PBT, containing fibres and a gel. As shown in the enlarged detail of FIG. 5(b), each fibre unit 502 in the modified cable comprises two or more optical fibres 506 embedded in a solid resin material 520 to form a coated fibre bundle having an outer surface 522. The resin 520 may in particular be a radiation-cured resin, for example UV cured resin, for example an acrylate. Suitable resins are readily available, and similar to the second layer of a typical primary coating 528.

The selected resin has a relatively high glass transition temperature, so that it is not rubbery, but rather solid as it encases the fibres 506 and locks them into a unitary structure. The elastic modulus of the resin material 520 is greater than 100 MPa, for example in the range 300 to 900 MPa. For the purposes of installation and operation, resin material 520 has a hardness (modulus) and tensile strength such that the individual optical fibres 506 are locked in a bundle, and substantially prevented from moving relative to one another, and/or relative to the resin material 520. This coated fibre bundle therefore has a unitary structure and stiffness very different from the loose individual fibres contained within the conventional fibre unit 102 of the known pullback cable 100. On the other hand, the resin material 520 is not so hard and strong that it cannot be broken away from the fibres 506, when access to the individual fibres 506 is required for termination and/or splicing.

The coated fibre bundle in turn is surrounded by an extruded polymer sheath 524. This type of fibre unit 502 has a structure similar in many respects to a cable assembly of the type disclosed in published international patent application WO2004015475A2. Such fibre units have been designed, and used for many years, for installation by blowing with air or other compressed fluid. Fibre units of this type are known to blow hundreds and even thousands of metres, in microducts having a compatible low-friction lining. However, they can also be installed by pulling and/or pushing, depending on the distance and the route involved. The outer sheath 524 is extruded onto the optical fibre bundle during manufacture of the fibre unit, which occurs in advance of manufacture of the pullback cable. The outer sheath in the known fibre unit for blowing is made of HDPE, with a friction reducing additive and optionally antistatic additives, colour etc. The outer sheath 524 protects the bundle and facilitates sliding of the bundle through the tube 504. By suitable control of the extrusion process, and selection of materials, the extruded outer sheath 524 can be prevented from bonding to the coated fibre bundle. This allows it to be ring-cut and removed by sliding over the outer surface 522 of the resin material, when stripping the fibre unit to access the individual fibres. If desired, the inner periphery of the extruded sheath 524 can be made longer than the outer periphery of the surface 522, so that the sheath slides freely at all times relative to the bundle, but this is not essential.

In contrast to the known blown fibre units, however, the material of the extruded outer sheath 524 of each fibre unit in the modified pullback cable of FIG. 5 is based on polybutylene terephthalate (PBT) polymer not HDPE. The PBT sheath may be more robust against accidental tearing than the easily-torn the PVC sheath, mentioned above. The locking of the fibres in the resin avoids tensile strain falling unequally on individual fibres as well (assuming they are under equal tension when locked into the resin). The PBT material may be similar to what is used in the conventional loose tube, but it may also be augmented with additives to reduce friction and change other properties.

The stripping of the outer sheath of the fibre unit may be by the same sliding action as in the known blown fibre units. However, in some embodiments of the present invention, the PBT sheath fits tightly onto the resin bundle. In that case, there is no free sliding, and a longitudinal cut and peeling technique may be employed to remove a required length of sheath.

The dimensions of the coated fibre bundle and the fibre unit as a whole depend of course on the number of optical fibres contained therein. The components of the fibre unit 502 in FIG. 5(b) are not shown to scale. For a two-fibre unit as shown, the outer diameter of the coated fibre bundle might be in the region of 700 to 900 μm (0.7 to 0.9 mm). The thickness of the extruded sheath 524 might be in the range 100 to 300 μm, for example approximately 200 μm. Thus, the diameter of the fibre unit as a whole may be in the order of 1 mm, for example 1.1 mm or 1.2 mm. The number of optical fibres within each unit tube may vary, for example ranging from 2 to 12, as illustrated in WO2004015475A2. The outer diameter of a fibre unit containing 12 fibres might be, for example 1.6 mm or 1.8 mm. All of the fibre units in the illustrated example comprise two optical fibres, but some or all of the fibre units in another example product may contain four fibres, or a different number. As in the known pullback cable 100, the number of fibre units in the pullback cable, and hence the total number of optical fibres, may vary, with typical numbers being 12, 24 or 48 fibre units. Different and/or higher numbers are of course possible. The number of fibres within each fibre unit may vary between cables, and even between fibre units within the same cable, to provide flexibility of application. As just one example, a pullback cable holding ten 4-fibre units and two 12-fibre units could be made.

The inventors have recognised that fibre units adapted for installation by blowing have certain properties that would make them attractive for withdrawal by pulling from a pullback cable. For example, the coefficient of friction of the HDPE extruded sheath of the air blown fibre units compares favourably with that of the PBT unit tubes 102 currently used. Similarly, the withdrawn lengths might be expected to install easily in a branching duct, whether by pushing or pulling for short and medium distances, or blowing over longer distances. Unfortunately, the inventors have also recognised that merely substituting such fibre units for the fibre units 102 in the known pullback cable 100 would not be practicable. The reason for this is that the fibre units 102 must survive the process of extrusion of the extruded tube 104, while remaining free to slide in the finished product, and without suffering damage. As illustrated schematically in the detail FIG. 5(b), the extruded sheath 524 of the fibre units can come into contact with the lining 510 of the extruded tube 504. Since the extruded tube 104/504 is formed around the loose bundle of fibre units 102/502 by hot melting and extrusion of the polymer material, the polyethylene lining 110 of the conventional extruded tube 104 would be liable to melt and fuse with the polyethylene sheath 524 of one or more fibre units 502 during the extrusion process. This may not happen at all points along the product. But if it were to happen even at some points within a production run of hundreds and thousands of metres in length, it would render the pullback cable useless for its intended purpose.

By adopting the structure of the known blown fibre units, but selecting the outer sheath material to be PBT-based, the modified pullback cable 500 can be manufactured without this risk of fusing, and without varying the materials of the extruded tube 504. As mentioned in the introduction, PBT is chemically different to PE, and also has a higher melting/processing temperature, by typically 40 to 50° C. Accordingly, in the modified cable 500 at least a lining of the extruded polymer tube 504 of the pullback cable 500 can be formed using HDPE, optionally with friction reducing additives, the same as in the commercially available pullback cable.

As illustrated in FIG. 5(a), the extruded tube 504 in the modified pullback cable 500 is formed in two layers, including a thin lining 510 of polyethylene mixed with friction reducing additives (slip agents) and antistatic additives. This thin lining 510 is formed by coextrusion with a main body of the extruded tube 504. In other words, the extruded tube comprises a co-extrusion of the lining material within a main tubular body, so that the main body can be of a different composition to the lining. The thickness of the lining may be greater than 20 μm, but less than 300 μm, for example less than 200 μm. A range of thickness for example from 50 μm to 150 μm may be envisaged. The thickness should be great enough to be reliably formed, but need not be any thicker.

Depending whether the cable is for exterior or interior use, the polymer of the extruded tube 504 may vary. In an example for outdoors use, polyethylene, for example high-density polyethylene (HDPE) or medium-density polyethylene (MDPE) may be selected. For indoor use (within buildings) the polyethylene tube body may be substituted by a flame resistant, zero halogen polymer. Commercially-available grades of polymer for indoors use include Casico FR6083 (from Borealis Group), Eccoh 5995 (from PolyOne Corporation), Megolon® HF8110, and Megolon® S300 (from Mexichem Speciality Compounds).

In an alternative embodiment of the modified pullback cable, the lining of the extruded tube may be simply the inner surface of the main body.

The manufacturing method and general structure of the product are readily adapted from the method of manufacturing the known pullback cable 100 described and illustrated above. In simple terms, for the manufacture of the pullback cable 500, the appropriate number of fibre units 502 with the extruded PBT-based sheath 524 are bundled together and passed through an extrusion die which forms the extruded tube 504 with the lining 510.

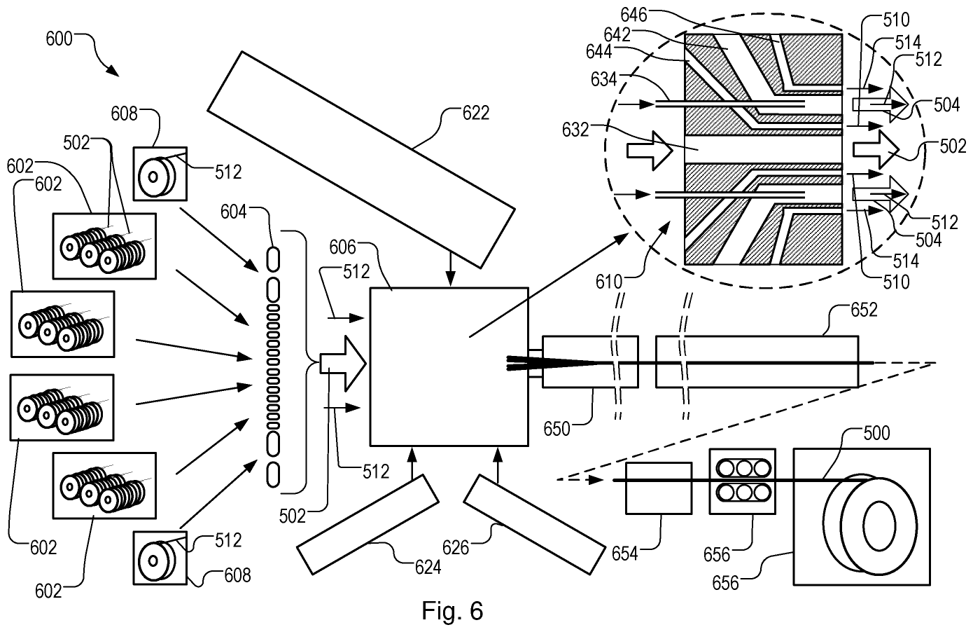

FIG. 6 illustrates schematically the apparatus 600 and processing steps used to manufacture the pullback cable 500 in one embodiment of a method of manufacture according to the present invention.

In advance of manufacturing the pullback cable 500, a desired number of fibre units 502, each containing the appropriate number of primary-coated optical fibres 506, are manufactured by a method such as that described in WO2004015475A2, modified by the use of the PBT-based material for the extruded sheath 524. Processing conditions for the PBT material (extrusion temperature, pressure etc.) will be substantially as for PBT loose tube extrusion, which is rather different from the settings of temperature and pressure for extrusion of the HDPE sheath on the known blown fibre unit. Additionally, as discussed further below, additional friction reducing additive may be included in the extrusion of the PBT sheath. The different fibre units 502 for the pullback cable are made with different colours of extruded sheath 524, and/or other markings so that they may be identified individually, when an opening is made in the finished pullback cable. Each fibre unit will be received, coiled on a reel or drum of suitable diameter, or coiled in pans. Payoff reels allow supply of cable with a designated back-tension.

For an example pullback cable 500 having 48 fibre units, four payoff banks 602 are provided, each delivering 12 individual fibre units 502 into the process. The payoff banks 602 deliver each fibre unit with a suitably controlled back tension, for example of a few hundred grams force. The individual fibre units are gathered into a guide plate 604 which, although illustrated here in a one-dimensional cross-section, is designed to guide the fibre units 502 into a desired two-dimensional array, for presentation to an extrusion head 606. A succession of guide plates may be provided, in practice, although only one is shown. Also shown are payoffs 608 for the strength members 512. As illustrated, these strength members also pass through dedicated openings in the guide plate 604, while they may be provided with dedicated guides in practice. To ensure good mechanical cohesion between the strength members and the surrounding polymer, a coating of heat-activated adhesive may be provided on the strength members when they are supplied.

The extrusion head 606 is shown only as a block in the middle of the drawing FIG. 6, with an enlarged schematic cross-section of an extrusion die 610 in the dashed oval at the upper right portion of the drawing. Extrusion head 606 including extrusion die 610 is supplied with hot melted materials to form the components of the extruded tube 504. A main body extruder 622 delivers the material for the main body of the extruded tube 504. For a product to be used externally, the polymer material may be primarily MDPE, as described above, compacted by heat and pressure by the main body extruder 622 in a known manner. Processing temperatures for this MDPE material may be, for example in the range 165° C. to 175° C., and the extrusion pressure may be in the range 130 to 160 bar, for example between 140 and 155 bar. For an indoor product, or in any case if different wall characteristics are desired, a different material may be used, with appropriate adaptation of the processing temperature and pressure.

A liner extruder 624 processes the polymer of the liner, for example HDPE with friction reducing and antistatic additives, and delivers it at high pressure to the extrusion head 606 to form the lining 510 of the extruded tube 504. The pressure of the liner extruder may be higher for the reason that the annular opening for the liner material is narrower, and a higher pressure is required to match the speed of extrusion of the liner to that of the main body. If very different materials are used for the liner and the main body, processing temperatures are chosen so that each material is not overheating the other, either within the extrusion head or when they come into contact. A stripe extruder 626 delivers polymer of a similar composition to the main body extruder, but with different colouring, into the extrusion head 606, to form the external markings 514 of the extruded tube 504.

As illustrated in the detail of the extrusion die 610, the 48 fibre units 502 are drawn together as a bundle through a central opening 632 in extrusion die 610, while extruding polymer tube 504 through annular channels in the die around the bundle. Dedicated tooling 634 delivers the GRP strength members 512 into the extrusion die 610 to become surrounded by the melted polymer which will form the main body of the extruded tube wall. The melted and pressurised main body polymer from main body extruder 622 enters extrusion die through channels 642. The melted and pressurised lining polymer from liner extruder 624 enters extrusion die through channels 644. The melted and pressurised marking polymer from stripe extruder 626 enters the extrusion die through channels 646 which extend only over the part of the circumference to be marked. In this way, the lining and main body of the tube 504 are extruded around the bundle of fibre units 502, while incorporating the strength members 512 and external markings 514 into the wall of the tube. As mentioned, a coating of adhesive may be provided on the strength members 512 to ensure they become structurally integrated with the tube wall. This adhesive, which is a dry and solid coating when the strength members are supplied, is activated by the heat of the melted main body material.

Downstream of extrusion head 606, a series of cooling tanks 650, 652 are provided, followed by a printing station 654. A tractor unit 656 of caterpillar or similar design applies the tension to draw all the elements of the cable 500 from the payoff banks 602, through the extrusion head and onto a take-up unit 656. In this way, the apparatus draws the extruded tube 504 and the bundle of fibre units through the extrusion die while process parameters of all the illustrated units are controlled to draw and cool the polymer tube to have finished interior and exterior dimensions such that the fibre units remain loose within the extruded tube 504.

Detail of the cooling tanks and control systems can be adapted from known cabling production apparatus, such as used for production of cables generally, and in particular for production of the pullback cable 100 which is already commercially available from various manufacturers. The requirement is to produce the pullback cable 500 in such a form that a selected fibre unit can be accessed and re-directed reliably by forming an opening in a wall of the tube and withdrawing a length of the selected fibre unit through the opening.

In an example apparatus, a first cooling tank 650 is a vacuum tank, for example between five and 10 m long. The application of a (partial) vacuum outside the extruded tube 504 helps the tube to keep its form and avoid collapse onto the bundle of fibre units 502. The second cooling tank 652 may be a longer tank, with water spray cooling, for example over 15 or more metres in length.

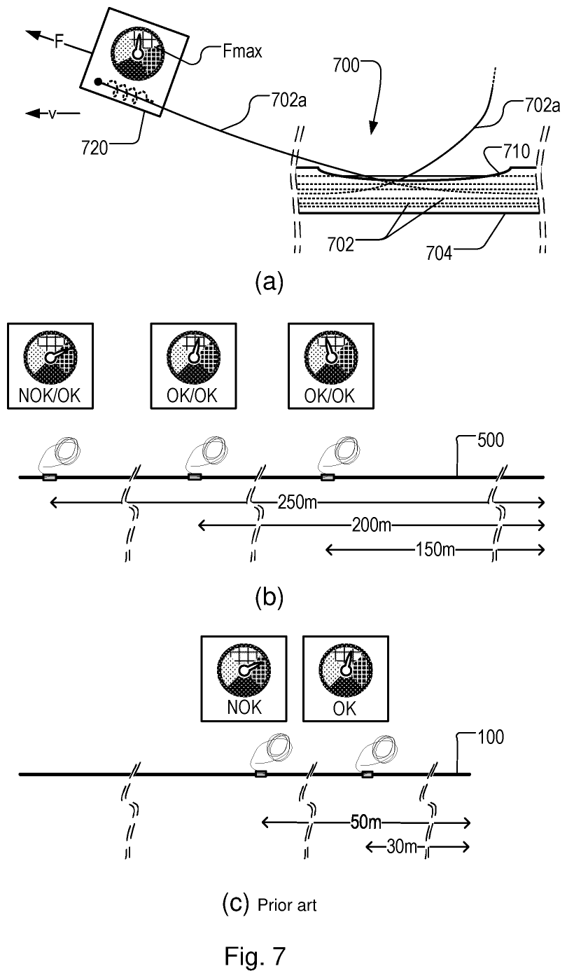

FIG. 7 illustrates the measurement of “tensile performance” of cables such as the pullback cable 500 of the present invention. The term “tensile performance” is generally used to refer to the pulling forces and deformations (stress and strain) applied to the product during installation. Other mechanical parameters such as minimum bend radius, crush resistance and the like are also specified for any commercially applicable product. Other parameters may be defined relating to longer term exposure to forces after installation. Typically, these parameters define forces to be resisted, in terms of maximum tolerable impact on optical performance, measured through the fibres.

As mentioned above, a key limitation with known pullback cables is the difficulty in withdrawing a sufficient length of a selected fibre unit, without exceeding tensile performance limits of the fibre unit. To measure the force required for withdrawal, a set up similar to that illustrated schematically in FIG. 7(a) may be used. A pullback cable 700 of whatever design is laid along a specified route. For a pullback cable, a relatively straight route laid out across a piece of ground may be specified, it may be a few hundred metres long, in any casecase longer than the maximum expected withdrawal length. The pullback cable, as described in the examples above, comprises fibre units 702 loosely arranged within an extruded tube 704. By cutting an opening 710, a selected fibre unit 702 may be accessed for withdrawal. The selected fibre unit may be cut and pulled out with only a single end, or it may be pulled out in a loop, without cutting. The beginning of the section to be withdrawn is pulled through the medium of a tensile force measuring instrument 720. In its simplest form, instrument 720 may be a simple spring scales, of the type used to measure weight of luggage or goods for sale, or it may be a digital tensile gauge. A weight reading in kilograms can be used as a proxy for tensile force measured in newtons (N). Each kilogram represents approximately 10 N, or more accurately 9.81 N, as is known. Alternatively, or in addition, the instrument may be calibrated directly in newtons. Rather than measure optical performance directly on the selected fibre unit, during and/or after withdrawal, a tensile performance specification for fibre units of this type will be established in advance. This will include a maximum tensile force Fmax, for example, which corresponds to a particular reading on the instrument 720, as labelled. The maximum force permitted for a given product, sometimes referred to in terms of the “proof strain”, depends on the construction of the product, including the properties of any sheath/unit tube and properties of the individual fibres within.

For practical purposes, withdrawal should be possible at a reasonable pace, without exceeding the tensile performance specification. A walking pace, for example 1 m/s or 1.4 m/s may be specified, as indicated by velocity v in the diagram. It is a matter of choice, whether the test is performed using an automated and calibrated carriage as a pulling device, or whether simply pulling by a human operator walking is accurate enough. For accuracy, tests are repeated multiple times, to ensure that a given performance can be reliably achieved in the field. The term “reliably” in this context may be understood to mean that any and all of the 24, 28, 96 or whatever number of fibre units in the pullback cable can be selected and withdrawn without exceeding the specified force.

FIG. 7(b) illustrates schematically the results of real tests performed on prototypes of the pullback cable 500 described above with reference to FIGS. 5 and 6, according to first and second examples discussed further below. A maximum force as a tensile performance parameter is defined for the product, based on its construction and the properties of its components. Bearing in mind that individual fibres within the modified pullback cable 500 are locked together in a matrix by resin material, it is reasonable to assume that the tensile performance parameter of the fibre unit is at least as great as the tensile performance of the individual fibres, multiplied by the number of fibres in the particular fibre unit. Safety margins may be built in, for example to specify that tensile performance for withdrawing the fibre unit should not exceed a certain percentage of the tensile performance of the individual fibres, multiplied by the number of fibres.

Accordingly, if the tensile performance of an individual optical fibre is specified as, for example 10 N force (roughly 1 kg weight), and if a 50% safety margin is applied, the tensile performance Fmax for the fibre unit comprising two, four, six, eight or twelve fibres can be specified simply as 10, 20, 30, 40 or 60 N, respectively.

Another force unit that may be used in measuring tensile performance of cables is the “W” unit, being the weight of a one-kilometre length of the cable product in question. Supposing that a fibre unit has a mass of 1.0 g/m, which may be typical for a 2-fibre or 4-fibre unit of the type used in the present disclosure. That corresponds to 1 kg/km, giving a force W=9.81 N. The parameter W for a 12-fibre unit weighing 2 g/m (i.e. 2 kg/km) represents a force W=19.6 N, and so on. The parameter W can therefore be used to obtain expressions of tensile force such as “1W” or “W/3”, which adapt automatically to different products. The tensile performance Fmax can then be expressed as multiples or fractions of the parameter W for a give fibre unit, such as W or 3W/4 and the like.

### Pullback Cable Examples and Test Results

Different embodiments are disclosed, depending on the composition of the PBT sheath. The extruded sheath may comprise a commercially-available PBT material designed for loose tube optical fibre applications. The extruded sheath may comprise a commercially available PBT material such as a grade of BASF Ultradur® 6550. Samples described herein have been made using BASF Ultradur® B 6550 LN in particular. Other grades of PBT may be used with suitable adaptation. The preferred grade will combine desirable properties for processing, finished product performance and cost. Certain grades may allow a thinner sheath, or easier processing, but at greater cost. For example, BASF Ultradur® B6550LNX is a high viscosity extrusion grade for microtubes in fibre optical cable applications, offering potentially thinner sheath. PBT is of course available from manufacturers other than BASF.

In a first comparative example of pullback cable 500 the sheath 524 of the fibre unit is made using BASF Ultradur® B 6550 LN polymer without additional friction reducing additives. Thirty 4-fibre units were included within the extruded tube. Pull back tests by the method of FIG. 7 have been performed with results shown in Table 1. Starting at 250 m a window cut 710 was made in the and a random fibre unit 702a selected. The fibre was attached to a digital tensile gauge and pullback attempted. The maximum tensile load and speed of pullback was recorded. A maximum force of around 20 N (2 kg weight) was set as tensile performance parameter Fmax (equivalent to 50% of proof strain). This scenario was repeated at 25 m increments until the fibre unit could be pulled without exceeding the maximum tensile load Fmax. It will be understood that the friction decreases progressively as the section of fibre unit is withdrawn, being greatest at the start of the withdrawal. Selecting a random fibre unit, it was found that sections of fibre unit of 75 m and 100 m in length can be reliably withdrawn without exceeding the maximum force (force reading “OK” in the drawing). On the other hand, withdrawing a length of 125 m or more tends to exceed the maximum force (force reading “NOK”), even when going more slowly.

TABLE 1
(PULLBACK TEST, FIRST COMPARATIVE EXAMPLE)

| Location | Force | Comments | Speed | Result |
|---|---|---|---|---|
| 250 m | 3.8 Kg | Load too High | Very Slow | NOK |
| 225 m | 3.4 Kg | Load Too High | Very Slow | NOK |
| 200 m | 3.5 Kg | Load Too High | Very Slow | NOK |
| 175 m | 3.5 Kg | Load too High Snapped Fibre | Slow | NOK |
| 150 m | 3.4 Kg | Load Too High Snapped Fibre | Slow | NOK |
| 125 m | 3.0 Kg | Load Too High | Medium | NOK |
| 125 m | 2.8 Kg | Load too High | Medium | NOK |
| 100 m | 1.8 Kg | Easy Pull | Medium | OK |
| 100 m | 1.4 Kg | Easy Pull | Medium | OK |
| 75 m | 1.1 Kg | Easy Pull | Fast | OK |
| 75 m | 1.0 Kg | Easy Pull | Fast | OK |

A second example was made where the sheath 524 of each fibre unit 502 comprised a mixture of polybutylene terephthalate PBT and additional friction reducing and/or antistatic additives. As before, the PBT material was BASF Ultradur® B 6550 LN. This PBT material is designed for loose tube optical fibre applications, and is believed already to contain a certain amount of friction reducing material (“lubricant” in the manufacturer's terminology). As mentioned above though, some embodiments according to the present disclosure are made with additional friction reducing additive. The additional friction reducing additive may comprise a silicon-based lubricant, for example a siloxane such as polydimethylsiloxane-based additive, for example a polyacrylate dimethyl siloxane. A polyacrylate dimethyl siloxane used in the second example is Dow Corning® HMB-1103 Masterbatch, which is available commercially as a “tribology modifier for polar engineered plastics such as polyamide (PA) and polyoxymethylene (POM)”. The amount of polyacrylate dimethyl siloxane may be between 1% and 5% by weight of the material of the extruded sheath, for example 2 or 3%. The amount to be included was determined during set-up tests of the extrusion process of the fibre units. The percentage can be increased in steps starting from 1%, say, until one finds that increasing the amount of additive adds to cost without adding to performance, or causes excessive flowing of the melt during the extrusion process. Below we describe examples with alternative PDMS-based additives.

The FIG. 7(a) pullback test was performed on this second example, with results as shown in Table 2. In this example, a mixture of 4-fibre and 12-fibre units were included. 265 m of pullback cable were laid out on the test track in a straight line. Starting at 265 m a window cut was made in the extruded tube and a random fibre unit selected, either 4-fibre (4 fu) or 12-fibre (12 fu). The fibre unit was attached to the digital tensile gauge and pullback attempted. The maximum tensile load and speed of pullback was recorded. As before, the intention was to repeat the test at 25 m increments until the pullback met the requirements. The maximum pull force selected was 0.5 kg per fibre, so 2kg for a 4-fibre unit (equivalent to 50% of proof strain).

As seen in the table, every selected fibre unit pulled easily from the cable over the full length of 265 m without exceeding the permitted maximum force. There was no need to perform the test at shorter increments.

TABLE 2
(PULLBACK TEST, SECOND EXAMPLE)

| Location | Force | Comments | Speed | Result |
|---|---|---|---|---|
| 265 m | 0.5 Kg | 4 fu Blue | Fast Paced Walk | OK |
| 265 m | 0.5 Kg | 4 fu White | Fast Paced Walk | OK |
| 265 m | 0.5 Kg | 4 fu Yellow | Fast Paced Walk | OK |
| 265 m | 0.5 Kg | 4 fu Orange | Fast Paced Walk | OK |
| 265 m | 0.4 Kg | 12 fu Orange | Fast Paced Walk | OK |

Summarising these results, we see that the modified pullback cable, in which fibre units based on bundles of fibres embedded in a resin core are sheathed in a PBT material, allows selected fibre units to be pulled over a length of at least 100 m. In the second example, with additional friction reducing material, fibre units could be pulled over a length in excess of 200 m, in fact in excess of 250 m.

By way of contrast, results of pullback tests using a conventional pullback cable 100 are illustrated schematically in FIG. 7(c). Note that the tensile performance parameter Fmax may be very different, typically lower, for the loose tube fibre units of the conventional pullback cable. There can be several reasons for this. Strength of the unit tube 104 may be more important than strength of the individual fibres, because the fibres are not locked in a unitary matrix. Moreover, because the fibres are not locked together in a unitary matrix, stresses transferred to the fibres through the unit tube may be imposed unevenly on individual fibres, rather than being shared equally between them. Furthermore, filling the PBT sheath with a relatively rigid resin material, rather than the conventional fillers of a loose tube construction may be expected to prevent “necking down” of the PBT sheath, which is a mode of failure in conventional loose tube fibre units when subjected to excessive tensile force. The test illustrated in FIG. 7(c) was performed on fibre units comprising two fibres per fibre unit, encased loosely in PBT unit tubes, with a maximum force specified of 15 N. As mentioned above, above this value, undesirable stretching of the unit tube may occur. In contrast to the modified pullback cable 500, it was found that no more than 50 m of a selected unit tube could reliably be withdrawn, without exceeding this performance. A safe limit of 30 m was defined.

As will be appreciated, unless the distance from each customer access point to the pullback cable route is less than 30 m, using the modified pullback cable 500 will allow the same premises to be connected with far fewer cuts and withdrawal steps, resulting in a much faster and cheaper installation overall, and with less disruption of the ground. Referring to the example of FIG. 4, therefore, the openings C2 and C4 become unnecessary, and potentially the opening C1 as well. Instead of separate withdrawal steps S1 and S2, a single withdrawal step can be used to withdraw the required length fibre unit from opening C3. Instead of separate installation steps S3 and S4, a single installation step is required to get the modified fibre unit 502 from the opening C3 to the premises access point 306. As is known by the skilled person, the distance that a length of optical fibre cable can be installed by pulling or pushing may be significantly less than what can be obtained by blowing, but it may be adequate, for example for short drops within a building, or from street to building.

In further experiments, it has been shown that the modified fibre units with PBT sheath can be pushed substantial distances, for example 30 m. Pushing distances are further enhanced in the second example with additional friction reducing additive. In this example, pushing into a drop tube can be performed up to 50 m, and over 90 m has been achieved in 4-fibre and 12-fibre designs. Pulling into a drop tube has been performed up to 100 m. These distances cannot be matched by conventional PBT loose tube fibre unit. As discussed further below, the fibre units with PBT sheath can also be suitable for installation by blowing, potentially allowing even longer distances.

Optical performance of the fibre units under temperature cycling is more than satisfactory in tests.

Ease of stripping of the sheath from a fibre unit to access the individual fibres is also an important characteristic for a practical product. In tests the fibre units with PBT+ sheath have been stripped quickly and without damage in lengths of 3 m. Since the PBT+ sheath may be tougher and/or tighter on the fibre bundle than the HDPE+ sheath of the known blown fibre units, a different stripping method may be preferred to the “sliding” method. Stripping may be performed using a tool to carefully cut longitudinally along the length of the sheath. A Miller MSAT16 stripper from Ripley Tools is a suitable tool. Short lengths of product were stripped using the MSAT 16 stripper. In testing, different settings were checked by carrying out short tests on sample product to establish the optimum setting. Once the optimum setting was found, 10×3 m samples were stripped and checked for any damage to the acrylate and bundle. Care was taken to pull the strippers over the product in a straight line, and at a steady pace.

Using the modified pullback cable 500, the benefits of the pullback cable principle can be extended to a much wider range of applications. Because the strength members 112 are provided in the extruded tube 104, and there are no separate strength members in the fibre units 102, the overall design can be very compact, compared with what would be required to accommodate the same number of fibre units as individual cables. The diameter of the extruded tube, and hence the overall diameter of the pullback cable itself, may be on the order of 15 to 20 mm. For example, the cable size may be designated “15/9”, meaning an outer diameter of 15 mm combined with an inner diameter of 9 mm. Note that the bore of the tube 104 is slightly oval, so that the strength members 112 and stripes 14 can be accommodated in thicker portions of the wall. Away from these thicker portions, it can be deduced that the wall thickness, including any lining, is 3 mm. Another example may have a size 16/10, meaning an outer diameter of 16 mm combined with an inner diameter of 10 mm. Again, the wall thickness away from the thickened portions is 3 mm. Another example may have a size 20/16, with a wall thickness of 2 mm.

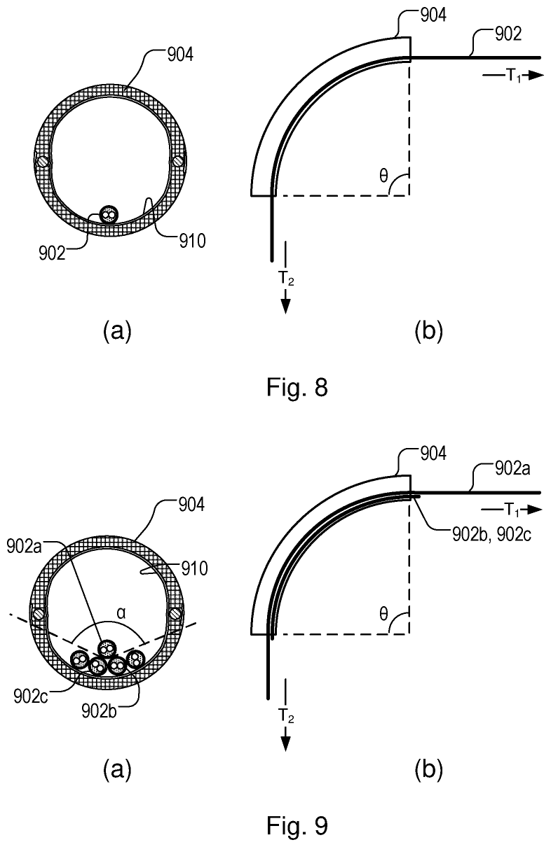

FIGS. 8 and 9 illustrate friction tests, which may be used to characterise the fibre units and/or tube linings in pullback cables. FIG. 8 illustrates a first fiction test, which measures a coefficient of friction μ between a representative fibre unit 902 and the lining 910 of the extruded tube 904, illustrated schematically at (a). The test applied is a well-known “capstan” test, in which the elongate moving element (fibre unit 902) is pulled around a certain angle of wrapping θ with a moderate non-zero velocity, while in contact with the stationary element, lining 910. A tension T₁ applied in the direction of pulling is measured, while being countered by a known tension T₂ applied in the reverse direction at the opposite end of the moving element. This is illustrated schematically at (b) in the drawing. The tension T₂ may be a fixed tension applied by a simple suspended weight, while the tension T₁ is measured by a suitable instrument. The angle θ is 90°, in this illustration, but angles, including angles greater than 180° or greater than 360° can also be used.

The ratio of the forces T₁ and T₂, according to a mathematical model of the capstan test, is determined by the wrap angle θ and the coefficient of friction μ, in accordance with the formula of Equation 1.

$$\frac{{T}_{1}}{{T}_{2}} = {e}^{μ θ} \qquad Eq . 1$$

Therefore, when T₁, T₂ and θ are known from the experiment, the coefficient of friction μ can be determined for a given combination of fibre unit and tube lining using Equation 2.

$$μ = l n \frac{{T}_{1}}{{T}_{2}} / θ \qquad Eq . 2$$

FIG. 9 illustrates a similar test, but adapted for measuring friction between fibre units of the same type, rather than between a fibre unit and a tube lining. The setup is shown in cross-section at (a) in the drawing, and in a side schematic detail at (b). For this second friction test, a number of fixed fibre units of the same type are held stationary, between the tube lining and the moving fibre unit. The moving fibre unit is labelled 902a, while the fixed fibre units are labelled 902b, 902c. consequently, the moving fibre unit slides not over the tube lining 910, but over the sheaths of other, similar, fibre units.

Depending on the setup, it may be considered to use a modified formula. For example, it is known that the above formula for the simple capstan model can be modified into a “V-belt” model, in which the moving element sits between two fixed sides having an angle α between them. This angle α becomes a further parameter taken into account in the modified formula:

$$\frac{{T}_{1}}{{T}_{2}} = {e}^{μ θ / sin ( \frac{α}{2} )} \qquad Eq . 3$$

The situation illustrated in FIG. 9(a) could be likened to a V-belt with an angle α of approximately 120°, and Equation 3 applied. However, for practical purposes, it has been found more convenient to use the same simple capstan formula Equations 1 and 2 to determine the coefficient of friction for both types of test. In many cases, one is interested in relative properties of samples, rather than absolute values.

Table 3 presents results of tests on a number of samples including the known pullback cable 100 and the new pullback cable 500, as described above. Six tests are performed, each one using four or five different samples to obtain a statistical average. Test A corresponds to the known pullback cable 100, having two fibres (2 fu) contained loosely in PBT unit tubes, within a duct lined with a liner comprising HDPE mixed with antifriction and antistatic additives (designated “HDPE+” in the table). The first type of friction test (FIG. 8) is applied to measure friction between a fibre unit and the tube. Test B is the same, but using a 2-fibre unit having a ribbed HDPE+ sheath, being the known blown fibre unit. Test C is the same as Test B, but using a 2-fibre unit having a ribbed sheath of polypropylene with additives (designated “PP+”). Finally, Test D performs the first type of friction test on an example of the modified pullback cable 500 of the present disclosure, in which the fibre unit has a PBT sheath with additional friction reducing material.

Comparing the results of Tests A to D in the Table 3, we see that the mean coefficient of friction between the PBT fibre unit and tube lining (Test A, μ=0.248) in the known pullback cable is significantly greater than any of the other samples. When a HDPE+ blown fibre unit with a ribbed sheath is used, the coefficient of friction is much lower (Test B, μ=0.125), but the problems of fusing would be expected in manufacture. When a blown fibre unit with a ribbed PP+ sheath is used (Test C), the coefficient of friction is between that of Test A and Test B, with significant variance. On the other hand, when the PBT sheath with additional friction reducing material is used, according to the present disclosure, the mean coefficient of friction μ measured over a number of samples is lower than any of the other examples (Test D, μ=0.115), less than 0.2, and in fact less than 0.15.

TABLE 3
COEFFICIENT OF FRICTION IN PULLBACK CABLE
μ (FIG. 8 - Fibre Unit v Extruded tube lining)

| | Sample No. | 1 | 2 | 3 | 4 | 5 | Mean |
|---|---|---|---|---|---|---|---|
| A | PBT Loose tube | 0.219 | 0.289 | 0.252 | 0.249 | 0.232 | 0.248 |
| B | HDPE + Sheath | 0.140 | 0.094 | 0.161 | 0.129 | 0.100 | 0.125 |
| C | PP + Sheath | 0.163 | 0.332 | 0.064 | 0.119 | 0.224 | 0.180 |
| D | PBT + Sheath | 0.136 | NR | 0.115 | 0.107 | 0.101 | 0.115 |

μ (FIG. 9 - Fibre unit v Fibre unit)

| | Sample No. | 1 | 2 | 3 | 4 | Ave | SD |
|---|---|---|---|---|---|---|---|
| E | PBT Unit Tube | 0.247 | 0.312 | 0.343 | 0.328 | 0.31 | 0.03 |
| F | HDPE + Fibre Unit | 0.148 | 0.193 | 0.206 | 0.192 | 0.18 | 0.02 |

Moving to the second type of test, illustrated in FIG. 9, the following comparative results are also shown in Table 3. Test E measures the friction between fibre units having the conventional PBT unit tube construction. Test F measures the friction between the known blown fibre units having the HDPE+ sheath. Accordingly, it may be expected that Test E represents the friction for a typical fibre unit being pulled from the middle of a pullback cable of known type, while Test F represents the friction for a typical fibre unit being pulled from the middle of a modified pullback cable according to an example having HDPE+ sheath.

As will be seen from the table, the coefficient of friction between fibre units having the HDPE+ sheath is much lower than that in the known cable 100 having PBT unit tubes. The coefficient of friction μ=0.18, measured by the method of FIG. 9 and Equation 1, is on average less than 0.22, in fact less than 0.2, where the known fibre units have a coefficient of friction of around 0.3. For the case of fibre units having a resin-coated fibre bundle and a PBT+ sheath, as proposed in the present disclosure, frictional forces would be expected to be similar or even lower than seen in Test F, that is less than 0.2, possibly less than 0.15. This confirms that the forces required to withdraw a given length of a selected fibre unit in the real product may therefore be expected to be substantially lower than in the known product.

In conclusion, and bearing in mind that Tests A and E represent the known product, while Test D represents the product made according to the present disclosure, the present disclosure provides a pullback cable which can be manufactured by extrusion of the extruded tube around a plurality of PBT-sheathed fibre units, and with friction coefficients lower than those in the known pullback cable. Combined with the superior strength of the modified fibre units, in which the fibres are embedded in a solid resin material, the length of fibre unit that can be retrieved without damage is greatly increased, as demonstrated in FIG. 7.

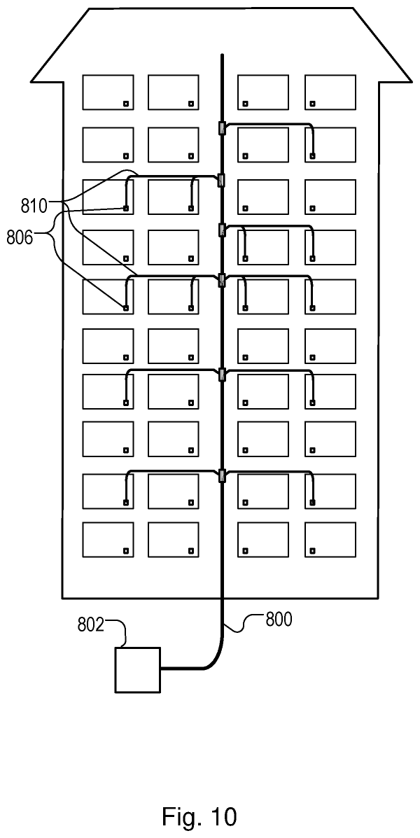

FIG. 10 illustrates how pullback cables can be used also within premises, as well as externally. A particular application for pullback cables is in risers, in multi-storey buildings. As illustrated, a modified pullback cable according to the present disclosure is used as a riser cable 800. Branching of individual fibre units is provided through micro-ducts 810 to connect premises access points 806 to the distribution point 802. The micro-ducts can be installed as and when needed, or they may be installed to every premises at the same time as the riser 800.

As mentioned above, the requirement of the lining of the extruded tube in the modified pullback cable according to the present disclosure is that it should not damage and/or adhere to the extruded sheath of individual fibre units, even through the process of extrusion of the extruded tube 504 around the bundle of pre-manufactured fibre units. PBT, with or without additives, has been mentioned as a material suitable for the extruded sheath 524 of the fibre units, which will not be damaged by the extrusion of an HDPE-based extruded tube 504. As an alternative to HDPE, a lining of the extruded polymer tube may comprise other polymers, for example primarily polypropylene or primarily nylon. Grade 11 or 12 nylon may be suitable, for example. Nylon has the benefit of hardness and low friction, but will typically be more expensive than polypropylene, and both are typically more expensive than HDPE. If the lining of the extruded tube is a different material than the main body, extra care may be required to avoid delamination of the lining from the body of the extruded tube 504. Such considerations are reduced, if the material of the lining and the tube body are the same, or are grades or blends of the same type of polymer, for example polyethylene.

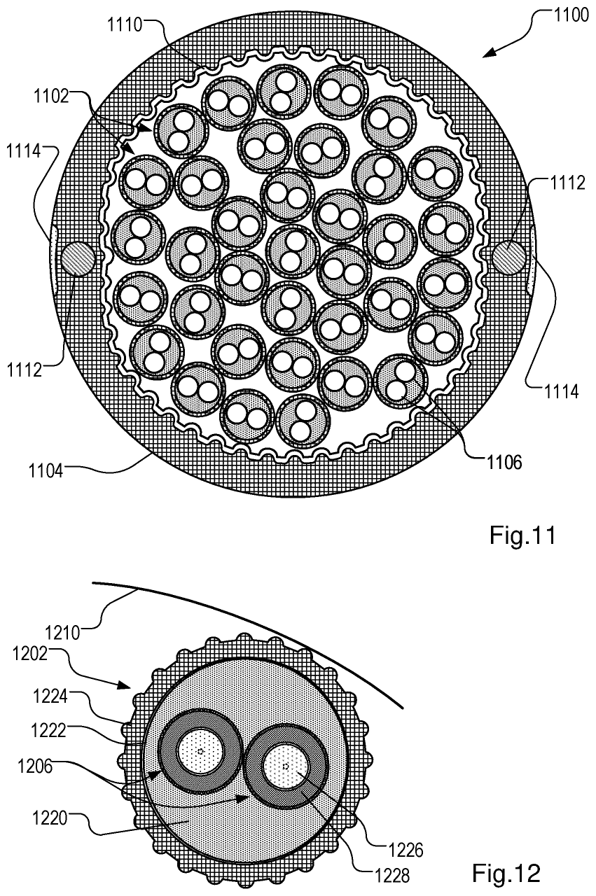

FIG. 11 illustrates a cross-section of a modified pullback cable 1100 according to another embodiment of the present invention. The features of the pullback cable 1100 correspond with similarly-numbered features those of pullback cable 500 shown in FIG. 5(a), but the references used are preceded with 11 instead of 5. The cable 1100 thus comprises a plurality of fibre units 1102 extending in parallel with one another within an extruded polymer tube 1104. Each fibre unit 1102 includes a plurality of individual optical fibres 1106. As in the known pullback cable 500, the fibre units 1102 are free to slide relative to one another and relative to the tube 1104 such that a selected fibre unit 1102 can be accessed and re-directed by forming an opening in a wall of the tube 1104 and withdrawing a length of the selected fibre unit 1102 through the opening.

Other features and advantages of the pullback cable 1100 the same as described above for pullback cable 500. The same alternatives and modifications also apply. Only the differences from pullback cable 500 will now be described in a little detail.

The modified pullback cable 1100 differs from the pullback cable 500, illustrated in FIGS. 5(a) and 5(b) because the lining 1110 of the tube 1104 includes an internally ribbed or undulating profile. To manufacture such a tube 1104, the extrusion tooling used to form the tube may for example include a tip of profiled cross-section, such that the ribbed profile is applied directly to the lining 1110 and the body material which presses in behind it. The term “ribs” and “ribbed” as used herein are not intended to imply any particular shape or distribution. Any form of projection that can be imparted during extrusion to reduce the contact area can be employed.

The inclusion of this ribbed profile reduces a contact surface area between a fibre unit 1102 and the lining 1110 of the tube 1104, during manufacture and use. The reduced surface contact during use of the product provides for easier retrieval/pullback of fibre units 1102 from the cable 1100. During manufacture, reduced contact surface area reduces the risk of these surfaces sticking together when the tube 1104 is extruded over the fibre units, and may therefore permit a large number of fibre units to be included within the same diameter of tube 1104, without manufacturing problems.

FIG. 12 shows schematically the form of a modified fibre unit 1202. The features in FIG. 12 correspond with those in FIG. 5(b), but the references used are preceded with 12 instead of 5. The fibre unit 1202 has the features and advantages of fibre unit 502, and all of the alternatives and optional features described above apply here also. Only the differences will be described in detail.

Compared with the example 502, extruded polymer sheath 1224 in the fibre unit 1202 provides a ribbed or undulating profile. The ribbed or undulating profile reduces the contact surface area between a fibre unit 1202 and the lining 1210 of the tube. This is illustrated in FIG. 12, where it is evident that a single peak of one undulation is in touching contact with the lining 1210. Ribs may be formed for example by a suitably formed die in the extrusion of the sheath 1224 over the coated fibre bundle.

In designing and manufacturing a pullback cable, the ribbed fibre unit 1202 can be used in combination with a tube 504 having smooth-lining, or a tube 1104 having a ribbed lining. Similarly, the tube 1104 having the ribbed inner surface can be used in combination with a ribbed fibre unit 1202 or a fibre unit with a smooth or other-textured surface.

As mentioned in the introduction, the polymer of the extruded polymer sheath 524/1224 may include various additives, such as for friction reducing, colouring, UV protection, antistatic etc. While conventional PBT material for loose tube fibre units may include some friction reducing component, additional friction reducing material is be included in the sheaths of the fibre units of this modified pullback cable. The additional friction reducing additive may comprise a polydimethylsiloxane material, PDMS, in a carrier material. The carrier material in particular examples is a polyacrylate material, for example a copolymer of ethylene and methyl acrylate, EMA. In other examples the carrier is a polyolefin, such as low-density polyethylene (LPDE). The additive may be called a polyacrylate dimethyl siloxane. More generally, the additive may comprise a silicon-based material including a polyether modified polydimethylsiloxane material such as a polyether modified hydroxy functional polydimethylsiloxane material. Alternatively, or in addition, forms of carbon including carbon nanotubes, erucamide and/or oleamide materials may be used for improving slip and reducing friction. As is known, different additives can take different amounts of time to migrate to the surface and deliver their benefits of lowering friction. The polymer may also include cross-linked material and/or fillers.

The density of the sheath material will depend on the materials blended into it, as well on processing conditions.

According to other embodiments, cross-linking may optionally be applied to the body of the extruded tube 504/1104, and optionally in the lining.

### Further Examples of Materials and Applications

In addition to friction reducing properties, it has been mentioned already that the selection and proportion of additives has an influence on the extrusion process. That is to say, the additives alter the behaviour of the molten material during extrusion, as well as the bulk and surface properties of the finished product. The quantity of additive used may be limited to avoid excess flowing of the melt, even if a greater proportion of additive might be beneficial for frictional properties in the finished product.

The inventors have found that a further class of siloxane-based additives different to the above-mentioned polyacrylate dimethyl siloxane can be used to obtain friction reduction in the PBT sheath of fibre units, without causing problems in extrusion. An example of this class is Dow Corning® MB 50-002 Masterbatch, which is available commercially as a formulation containing 50% of an ultra-high molecular weight (UHMVV) siloxane polymer dispersed in low-density polyethylene (LDPE). It is designed to be used as an additive in polyethylene compatible systems to impart benefits such as processing improvements and modification of surface characteristics, according to the manufacturer's datasheet. The MB50-002 additive is promoted for (non-polar) plastics such as polyethylene and is based on an LDPE carrier. Conventionally, incompatibility between the PBT and LDPE components would be expected to prevent mixing, leading for example to tearing of the sheath. Surprisingly such effects are found to be absent and the additive blends well. One explanation for this may be that the LDPE becomes “momentarily polar” due to oxidisation at the point where the thin tubular film exits the extrusion tip and die. This oxidation creates carboxyl groups, having the effect of making the PE of the masterbatch compatible, in that moment, with the polar polymer such as PBT.

Whatever the cause, the superior performance of the LDPE-based additive is a surprising discovery, since the polyacrylate dimethyl siloxane additive HMB-1103 is the one promoted by the manufacturer for use in polar plastics, including PBT. The same may be expected for PDMS additives promoted by other manufacturers.

As for the previous example, the amount of LDPE additives additive to be included can be determined during set-up tests of the extrusion process of the fibre units. The percentage can be increased in steps starting from 1%, say, until one finds that increasing the amount of additive adds to cost without adding to performance, or causes excessive flowing of the melt during the extrusion process. The amount of additive may be between 1% and 5% by weight of the material of the extruded sheath, for example between 2 and 4%, more particularly between 2.5 and 3.5%. A value of 3% has been found suitable, bringing further enhancement in friction performance, without the extrusion problems that would be encountered using the polyacrylate dimethyl siloxane additive. The masterbatch MB50-002 has a loading of PDMS of 50%, which may be high compared with the (unknown) percentage in the HMB-1103. Based on the value of 50% and the inclusion of 3% of the additive as a whole, it will be seen that the overall siloxane content of the sheath material is around 1.5%, i.e. greater than 1%.

As for the earlier examples, the PBT polymer sheath in these examples may also be fully or partially cross-linked, for example to improve dimensional stability and/or high temperature performance. Other additives such as fillers, colouring, anti-static and the like may also be included.

In addition to the benefits relating to its use in pullback cables of the type described above, fibre units according to the invention have been found to perform very well as a blown fibre unit, matching or exceeding in some cases the performance of the fibre units known from WO2004015475A2, mentioned above. The different mechanical properties of PBT compared with HDPE, such as higher tensile modulus and yield strength, raise the possibility to reduce dimensions, and/or to implement different mechanical designs in the application of the cables.

### Blown Cable Examples

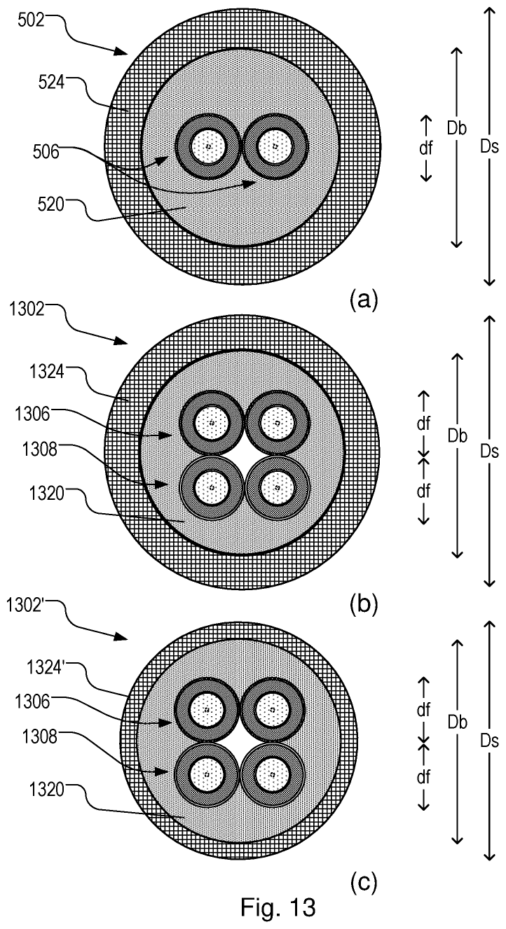

FIG. 13 presents three examples of fibre units with PBT sheath, which may be regarded as variants of the fibre unit 502 illustrated in FIG. 5. Each fibre unit 1302 in these examples comprises two or more optical fibres 1306 embedded in a solid resin material 1320 to form a coated fibre bundle having an outer surface 1322. The resin material 1320 again comprises a radiation-cured resin, for example UV cured resin, for example an acrylate. The selected resin has a relatively high glass transition temperature, so that it encases the fibres 1306 and locks them into a unitary structure. The elastic modulus of the resin material 1320 is greater than 100 MPa, for example in the range 300 to 900 MPa, or approximately 300 MPa.

As explained already above, such a resin material 1320 has a hardness (modulus) and tensile strength such that the individual optical fibres 1306 are locked in a bundle, and substantially prevented from moving relative to one another, and/or relative to the resin material 1320. On the other hand, the resin material 1320 is not so hard and strong that it cannot be broken away from the fibres 1306, when access to the individual fibres 1306 is required for termination and/or splicing.

The coated fibre bundle in turn is surrounded by an extruded polymer sheath 1324. This type of fibre unit 1302 has a structure similar in many respects to a cable assembly of the type disclosed in published international patent application WO2004015475A2. Compared with the HDPE sheath of the known low fibre unit, which already sets the standard for compactness and blowability, a PBT sheath has been found to offer yet further unexpected benefits in terms of low friction and compact size. While the HDPE sheath of the known blown fibre units is relatively thin and hard, relative to other designs available at the time, the PBT sheath according to the present disclosure may be significantly harder (stiffer) and/or significantly thinner than the sheath of the known fibre units.

For example, the HDPE sheath material may have a tensile modulus on the order of 1000 MPa (for example in the range 700 to 1300 MPa), while the PBT material has a tensile modulus on the order of 2500 MPa, for example 2600 MPa. Even allowing for some reduction in the modulus caused by the inclusion of a small percentage of friction-reducing additive in LDPE or polyacrylate carrier, the modulus of the PBT sheath material will be in excess of 2000 MPa, 2200 MPa and 2400 MPa. Likewise, the tensile strength (or tensile stress at yield) of PBT material can be significantly higher than that of HDPE. For example, tensile yield stress of HDPE is typically in the mid-20 s MPa, while the tensile yield stress of PBT can be greater than 40 MPa, typically 50 MPa or more.

A single such fibre unit, without being encased in any other structure, is found to be suitable for use as a fibre optic cable suitable for installation in microducts by means of blowing. As is known for the known blown fibre unit (WO2004015475A), the embedding of the optical fibres in a relatively solid resin provides a stiffness to the structure of the fibre unit, independent of the stiffness of the outer sheath. With the increased strength, hardness and stiffness of the PBT material relative to HDPE, a fibre unit better suited to pushing and pulling can be provided. Additionally, a fibre well suited to installation by blowing can be provided. The thickness and detailed composition of the PBT sheath can be adjusted and optimised for one particular installation method. To favour blowing, a thinner sheath can be provided, which is nevertheless a robust protection for the fibres contained within, and does not interfere with blowing performance. On the other hand, (as mentioned already above) a single design of fibre unit can have adequate performance in pushing, pulling and blowing. This is particularly useful in the case of a pullback cable, where a wide range of distances and topographies may exist between the pullback cable and the premises access points, between installations and even within the same installation.

Comparing the three designs shown in FIG. 13, the fibre unit 502 at (a) corresponds closely to the fibre units 502 already described above for using a pullback cable. Only two fibres 506 are included. The sheath 524 in this example is of PBT with a siloxane additive, for example an ultra-high molecular weight siloxane in an LDPE carrier, such as the one mentioned above. Assuming that the diameter df of the primary coated fibres is approximately 0.25 mm, the diameter Db of the coated fibre bundle is for example 0.77-0.78 mm, and the diameter Ds of the product including the sheath 524 is around 1.2 mm. The thickness of the sheath is accordingly a little over 0.2 mm, for example 0.21 mm. Note that coated optical fibres are now readily available in 0.2 mm diameter (200 micron), as well as 0.25 mm. Such smaller fibres can be used instead of 0.25 mm fibres, with a corresponding reduction in the size of all layers, if desired.

The fibre unit 1302 at FIG. 13(b) differs from the fibre unit 502 at (a) in that four optical fibres 1306 are in the coated fibre bundle. These may be four signal-carrying fibres. Alternatively, the pair of fibres shown with no colour in their outer coating layer may be “dummy” or “mechanical” optical fibres 1308 which are included in the resin bundle only to provide mechanical stiffness and symmetry. This is a feature known from existing blown fibre units, and it is intended that this particular fibre unit may be better adapted for blown installation than the one shown at (a). At the same time, performance in a pullback cable and/or for installation by pulling and/or pushing is also expected to be good. In this example, assuming that the diameter df of the primary coated fibres is approximately 0.25 mm, the diameter Db of the coated fibre bundle is for example 0.80-0.82 mm, and the diameter Ds of the product including the sheath 1324 is around 1.2 mm. The thickness of the sheath is accordingly about 0.2 mm, or a little under. The sheath 1324 in this example is of PBT with a siloxane additive, for example an ultra-high molecular weight siloxane in an LDPE carrier, such as the one mentioned above.

Now considering fibre unit 1302′ at FIG. 13(c), again four optical fibres 1306, 1308 are included in the coated fibre bundle. These may be four signal-carrying fibres. Alternatively, the pair of fibres 1308 shown with no colour in their outer coating layer may be “dummy” or “mechanical” optical fibres which are included in the resin bundle only to provide mechanical stiffness and symmetry. This is a feature known from existing blown fibre units, and it is intended that this particular fibre unit be better adapted for blown installation than the ones shown at (a) and (b). In this example, assuming that the diameter df of the primary coated fibres is approximately 0.25 mm, the diameter Db of the coated fibre bundle is for example 0.80-0.82 mm, but the diameter Ds of the product including the sheath 1324′ is around 1.05 mm. The thickness of the sheath is accordingly about 0.115 mm, much thinner than the examples (a) and (b). The sheath 1324′ in this example is of PBT with a siloxane additive, for example an ultra-high molecular weight siloxane in an LDPE carrier, such as the one mentioned above. Thanks to the inherent stiffness and strength of the PBT-based material, as well as the very low friction properties of the material, the sheath can have a thickness substantially less than 0.2 mm, for example less than 0.15 mm, as this example shows. Thickness in the range 0.05 to 0.15 mm can be envisaged.

It will be understood that the above are not the only designs of fibre optic cable that are possible within the scope of the present disclosure. A fourth example is described below, with reference to FIG. 19, in which additional elements are included within the coated fibre bundle.

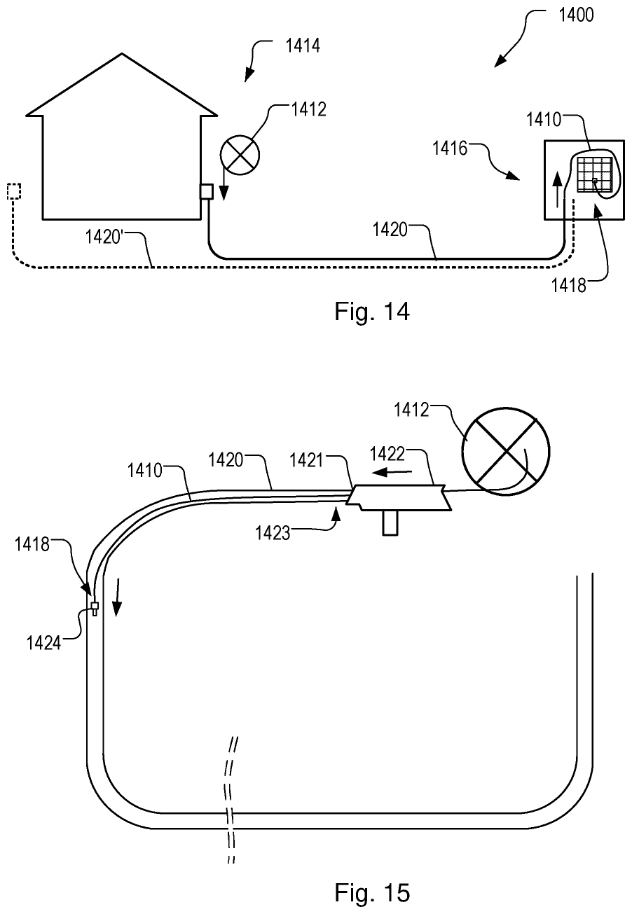

FIGS. 14 and 15 show an example of a Fibre to the Home (FTTH) installation 100 of optical fibres, using a length of fibre unit 1410, such as one of the fibre units 502, 1302, 1302′ of FIG. 13. It will be understood that terms such as “consumer” and “home” are used by way of example only, and the products and techniques described herein may equally be applied in commercial and industrial installations. Optionally one or more ends of the fibre unit has been terminated with a blowable connector component, typically a blowable optical ferrule 1424 with a ferrule body. The ferrule is installed on an individual one of the fibres, with the other fibre(s) in the bundle being spare for future use. In the illustrated example, a fibre unit is provided wound on a reel 1412 from which pre-terminated optical fibre or fibres are delivered from the consumer side/home side 1414 of the installation 1400 to the supply side, for example a telecommunications cabinet 1416. Instead of a reel 1412, the pre-terminated cable assembly may be provided in other forms, for example in a coil, in a fibre pan etc.

Referring also to FIG. 15, in the illustrated example the FTTH installation 1400 is performed by passing a leading end of the fibre unit 1410 into a pre-installed duct 1420. Other ducts 1420′ etc, lead from the same cabinet 1416 to other premises, so that this installation method may be repeated many times in a neighbourhood.

FIG. 15 shows, by way of example, installation by blowing from the consumer side of the installation to the supply side. A leading end 1418 of the pre-terminated fibre unit 1410 is transported through a duct 1420 at least partly by viscous drag created by compressed fluid, for example compressed air. A special blowing machine 1422 has a blowing head 1421 which is coupled to the receiving end 1423 of the duct 1420. It will be appreciated that the installation process may also be conducted from the supply side, for example a telecommunication cabinet 1416, to the consumer side, according to convenience.

The leading end 1418 of the fibre unit 1410, which includes a ferrule connector 1424, leads the installation of the optical fibre or fibres through the duct 1420. The leading end 1418 passes through the duct 1420 and is fed from the reel 1412 until the ferrule connector 1424 and a length of the optical fibre cable assembly 1410 exits the duct 1420 within the telecommunications cabinet (see FIGS. 14 and 15). A protective cap may be fitted over the ferrule 1424 while the installation takes place. A connector housing (not shown) may be added to the ferrule to make a complete connector for plugging into a mating socket. If desired, the fibre unit can be pre-terminated with the same or different connectors at both ends.

Particular forms of pre-terminated fibre optic cable assembly and methods of installation are disclosed in our earlier patent application WO2018146470A1 (Attorney's reference 11050PWO). The fibre units disclosed herein can be used as part of those assemblies and methods. An alternative form of pre-terminated optical fibre cable assembly and its use are described in another patent application GB21#####.# having the same filing date as the present application (attorney's reference 12009PGB).

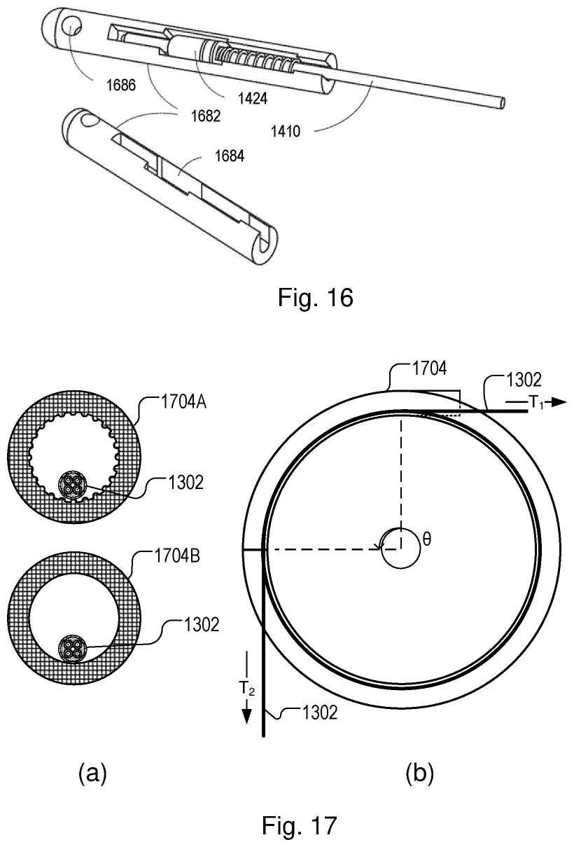

Similarly to the fibre units included in a pullback cable, the fibre unit designed primarily for blowing may also be adapted for pushing and/or pulling, when the need arises. An alternative or supplementary installation process illustrated in FIG. 16 involves physically pulling the leading end 1418 of the pre-terminated optical fibre cable assembly 1410 through the duct 1420. A pulling accessory 1682 provided as shown which has a recess 1684 adapted to receive the ferrule connector 1424 and leading end of the assembly 1410. The pulling accessory has a rounded end and a pulling eye 1686, by which it can be attached to a pulling line previously installed in a duct. For shorter installations, simply pushing the assembly through the duct may be practicable. The pulling force that can be applied without risking damage to the fibres is of course limited, especially if the route includes bends. On the other hand, it is expected that the PBT sheath provides more protection against tensile force than the conventional HDPE sheath, so that pulling performance is enhanced compared with the known blown fibre unit. This additional tensile performance can be associated with the material properties of the PBT material (with additive) as well as the tightness of the sheath on the solid coated fibre bundle.

### Blown Cable Test Results

Particularly in the form shown in FIG. 13(c), fibre units 1302 are well adapted to installation by blowing. In fact, it has been found that the modified fibre unit with the sheath material based on PBT can perform even better installation than the highly successful blown fibre unit with HDPE sheath, described in WO2004015475A2.

The first type of test, friction tests similar to those illustrated in FIG. 8, have been performed on PBT-sheathed fibre units with the construction shown in FIG. 13(c) in comparison with the known HDPE-sheathed fibre unit. As shown in FIG. 17(a), friction was measured relative to commercially available micro-ducts having outer/inner diameter 7/4 mm and having a low-friction HDPE liner. Some tests were performed with a micro-duct 1704A having a ribbed profile in the liner, and other tests performed with the micro-duct 1704B having a smooth liner, but otherwise identical. As shown in FIG. 17(b), the wrap angle θ for these tests was 450° (1¼ full turn). Tension was provided by a 200 g weight, giving a force T₂ of 1.962 N. Tension T₁ was recorded whilst pulling at a constant speed of 500 mm/min using a calibrated Lloyds tensile machine and 100 N load cell. Ten tests were conducted on each fibre unit/micro-duct combination. A fresh length of micro-duct and fibre was used for each test.

The fibre unit tested was the fibre unit 1302′ of FIG. 13(c) having two active fibres and two dummy fibres, and having 1.05 mm outside diameter (OD) with low-friction PBT sheath including the MB50-002 additive. The outer surface of this sheath is smooth. The construction and dimensions of the coated fibre bundle are identical between the two examples, the difference being entirely in the sheath. The first fibre unit tested as a comparative example was the commercially available Emtelle fibre unit having two active fibres and two dummy fibres, and having 1.1 mm outside diameter (OD) with low-friction HDPE sheath. The sheath of this unit has longitudinal ribs.

Coefficients of friction were calculated using the capstan Equation 2.

$$μ = ln \frac{{T}_{1}}{{T}_{2}} / θ \qquad Eq . 2$$

The results were as shown in the following Tables 4A (ribbed micro-duct) and 4B (smooth micro-duct).

TABLE 4A
(COEFFICIENT OF FRICTION μ -
7/4 MM RIBBED MICRO-DUCT)

| Test | 1.1 mm 2-FU HDPE | 1.05 mm 2-FU PBT |
|---|---|---|
| 1 | 0.083 | 0.034 |
| 2 | 0.085 | 0.039 |
| 3 | 0.083 | 0.010 |
| 4 | 0.079 | 0.048 |
| 5 | 0.087 | 0.043 |
| 6 | 0.035 | 0.052 |
| 7 | 0.039 | 0.046 |
| 8 | 0.031 | 0.051 |
| 9 | 0.044 | 0.052 |
| 10 | 0.039 | 0.048 |
| Mean | 0.061 | 0.043 |

TABLE 4B
(COEFFICIENT OF FRICTION μ -
7/4 MM SMOOTH MICRO-DUCT)

| Test | 1.1 mm 2-FU HDPE | 1.05 mm 2-FU PBT |
|---|---|---|
| 1 | 0.108 | 0.067 |
| 2 | 0.098 | 0.063 |
| 3 | 0.100 | 0.051 |
| 4 | 0.108 | 0.051 |
| 5 | 0.102 | 0.065 |
| 6 | 0.111 | 0.063 |
| 7 | 0.098 | 0.066 |
| 8 | 0.105 | 0.063 |
| 9 | 0.107 | 0.056 |
| 10 | 0.102 | 0.051 |
| Mean | 0.103 | 0.058 |

Without ascribing any significance to the absolute values of these results, what is clear from the tests is that the PBT-sheathed fibre unit of the present disclosure has a significantly lower coefficient of friction than the conventional HDPE-sheathed fibre unit. Moreover, the combination of a PBT-sheathed fibre unit and ribbed lining of the micro-duct provides the lowest friction of the four situations. Accordingly, in conjunction with a commercially available ribbed micro-duct, the PBT-sheathed fibre unit may be expected to perform even better in blowing the blowing method of installation. Of course, reduced friction would also indicate better performance in both pushing and pulling methods as well.

Having said that, blowing performance in a real application depends on many variables as well as the coefficient of friction. Various different testing regimes of blowing performance are known and used in the industry, including standard tests and custom tests for individual manufacturers and/or customers.

A long-established test, and one which is generally very challenging for blown fibre products, is the 500 m drum test.

For this test, 500 metres of a commercially available tube with outside diameter 5 mm and internal diameter 3.5 mm with smooth low-friction HDPE lining was wound onto a drum with barrel diameter of 500 mm. A length of fibre unit 1302′ with outer diameter 1.05 mm was made according to the example of FIG. 13(c). The PBT outer sheath had 3% of the additive MB50-002. The end of the fibre unit was bare, without termination. An Accelair2 blowing machine was used, supplied with air by a Kaeser M31 air compressor. Other makes of equipment are of course available.

The results are shown in Table 5. The fibre unit was installed successfully through the entire length in under 20 minutes. The cable travelled at a constant speed of 30 m/min. The air pressure and driving torque of the blowing machine were adjusted in the usual manner.

TABLE 5
((Blowing 500 m Drum Test; Micro-duct 5/3.5 mm Smooth)

| | | | Air | |
|---|---|---|---|---|
| Distance | Time | Speed | Pressure | |
| (m) | (mm:ss) | (m/min) | [symbol] | Torque |
| 0 | 0 | 30 | 0 | 30% |
| 50 | 2.06 | ″ | 6 | 35% |
| 100 | 4.1 | ″ | 8 | 40% |
| 150 | 5.48 | ″ | ″ | ″ |
| 200 | 7.3 | ″ | 10 | ″ |
| 250 | 9.1 | ″ | ″ | ″ |
| 300 | 10.4 | ″ | ″ | ″ |
| 350 | 12.1 | ″ | ″ | ″ |
| 400 | 13.4 | ″ | ″ | ″ |
| 450 | 15.1 | ″ | ″ | ″ |
| 500 | 17.4 | ″ | ″ | ″ |
| 550 | 19.1 | 30 | 10 | 40% |
| 600 | | | | |

[symbol]

indicates data missing or illegible when filed

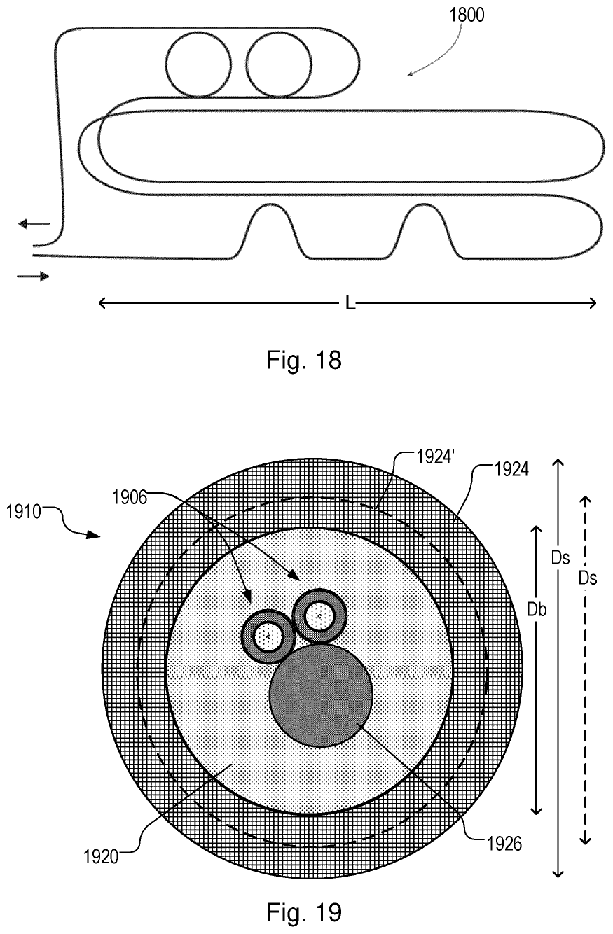

Further blowing tests were performed with the route shown schematically in FIG. 18. The route was 500 m in total using a 7/3.5 mm tube, and included various features, namely two simulated road crossings with 150 mm bend radius, two 180-degree bends with a radius of 200 mm, two 180-degree bends with a 150 mm radius, one 180-degree bend with 500 mm radius and two 360-degree loops with radius 300 mm. The overall length L of each section was 100 m.

Blowing was performed using lengths of fibre unit 1302′ with outer diameter 1.05 mm made according to the example of FIG. 13(c). The PBT outer sheath had 3% of the additive MB50-002. The end of the fibre unit had a blowable optical ferrule 1324 as termination.

Tests using this route were done with the fibre unit 1302′ soon after manufacture. It is known that performance can change over time, for example due to temperature induced coil set. To test for this, the tests were then repeated with fibre unit 1302′ which had been subject to temperature cycling, specifically 2 cycles 12 hours prior to the blowing trial between −10 degrees Celsius and +50 degrees Celsius. Tests using this route were done with two different compressors, different to the one used in the drum test.

Results are shown in Table 6A and 6B (different compressors; fibre unit before temperature cycling) and Table 7A and 7B (different compressors; fibre unit after temperature cycling).

TABLE 6A
(Compressor 1; fibre unit before temperature cycling)

| Distance | Time | Speed | Air Pressure |
|---|---|---|---|
| (m) | [symbol] | [symbol] | [symbol] |
| 0 | 0:00 | 30 | 2 |
| 50 | 1:49 | 30 | 2 |
| 100 | 3:29 | 30 | 2 |
| 150 | 5:10 | 30 | 4 |
| 200 | 6:51 | 30 | 2 |
| 250 | 8:31 | 30 | 2 |
| 300 | 10:12 | 30 | 2 |
| 350 | 11:53 | 30 | 2 |
| 400 | 13:33 | 30 | 2 |
| 450 | 15:14 | 30 | 3.5 |
| 500 | 16:54 | 30 | 3.5 |

[symbol]

indicates data missing or illegible when filed

TABLE 6B
(Compressor 2; fibre unit before temperature cycling)

| Distance | Time | Speed | Air Pressure |
|---|---|---|---|
| (m) | [symbol] | [symbol] | [symbol] |
| 0 | 00:00 | 46 | 0 |
| 50 | 01:11 | 34 | 0 |
| 100 | 02:15 | 46 | 2 |
| 150 | 03:22 | 46 | 2 |
| 200 | 04:27 | 46 | 2 |
| 250 | 05:35 | 46 | 2 |
| 300 | 06:41 | 46 | 2 |
| 350 | 07:45 | 46 | 2 |
| 400 | 08:50 | 46 | 2 |
| 450 | 09:56 | 46 | 2 |
| 500 | 11:01 | 46 | 2 |

[symbol]

indicates data missing or illegible when filed

TABLE 7A
(Compressor 1; fibre unit after temperature cycling)

| Distance | Time | Speed | Air Pressure |
|---|---|---|---|
| (m) | [symbol] | [symbol] | [symbol] |
| 0 | 00:00 | 35 | 2 |
| 50 | 01:37 | 35 | 2 |
| 100 | 03:02 | 35 | 2 |
| 150 | 04:26 | 35 | 4 |
| 200 | 05:50 | 35 | 4 |
| 250 | 07:20 | 35 | 4 |
| 300 | 08:42 | 35 | 4 |
| 350 | 10:07 | 35 | 4 |
| 400 | 11:32 | 35 | 4 |
| 450 | 12:59 | 35 | 4 |
| 500 | 14:23 | 35 | 4 |

[symbol]

indicates data missing or illegible when filed

TABLE 7B
(Compressor 2; fibre unit after temperature cycling)

| Distance | Time | Speed | Air Pressure |
|---|---|---|---|
| (m) | [symbol] | [symbol] | [symbol] |
| 0 | 00:00 | 35 | 0 |
| 50 | 01:29 | 35 | 2 |
| 100 | 02:56 | 35 | 2 |
| 150 | 04:26 | 45 | 2 |
| 200 | 05:47 | 45 | 4 |
| 250 | 06:53 | 45 | 4 |
| 300 | 08:14 | 50 | 4 |
| 350 | 09:16 | 50 | 4 |
| 400 | 10:15 | 50 | 4 |
| 450 | 11:16 | 50 | 4 |
| 500 | 12:14 | 50 | 4 |

[symbol]

indicates data missing or illegible when filed

These blowing tests have shown that the new fibre unit having a PBT outer sheath with PDMS additive and blowable optical ferrule can perform extremely well in blowing, requiring a very modest air pressure, especially bearing in mind the very convoluted route that has been laid out to simulate more challenging real-world installations. The temperature cycling did not adversely affect the blowing performance of the fibre units. The ability to install using lower air pressures has significant benefits in allowing the use of more lightweight and lower cost equipment. It can also be seen that the second compressor in the trial outperformed the first compressor considerably, with more than two minutes faster installation time.

### Further Example Pushable and Blowable Cable

FIG. 19 shows in schematic cross-section a further example fibre optic cable 1910 which is also blowable, but is optimised for pushing installation as well. This type of cable, sometimes referred to as “nanocable” is of similar construction to the fibre units 502, 1302, 1302′, but the coated fibre bundle includes at least one strength member. Thus, one or more optical fibres 1906 embedded in a solid resin material 1920 two former coated fibre bundle, as before, but the coated fibre bundle includes a longitudinal strength member 1926, made for example of fibre reinforced plastic (FRP). The extruded sheath 1924 of PBT-based polymer surrounds the coated fibre bundle, also as before. As is well known, such a strength member provides a degree of stiffness against bending, as well as strength against tensile forces.

In a known product of this design, with an HDPE-based sheath, such a cable has been found to have good blowing performance and excellent pushing performance. For example, with a ferrule sub-assembly pre-fitted on the end, a 2-fibre example has been pushed over 90 m through buried micro-duct of 7/3.5 mm dimensions with no difficulty. The lower friction of the PBT-based sheath may be expected to perform even better. The higher tensile stiffness and strength of the PBT-based sheath may also be expected to provide excellent pulling characteristics, but the vast majority of the product tensile strength is in the optical fibres and the FRP strength member(s), so that increased sheath strength may not be significant.

The strength member in this example is shown with a diameter of approximately 0.5 mm. An outer diameter of the fibre unit 1910 may be greater than that of the examples of FIG. 13, being for example in the range of 1.2 to 2.5 mm, for example in the range 1.2 to 2.0 mm, for example 1.2 to 1.8 mm. The extruded sheath 1924 in this example may have a thickness greater than that of fibre unit 1302′, and optionally greater than that of fibre units 502 and 1302. The extruded sheath 1924 in this example may have a thickness in the range 0.25 to 0.4 mm, for example 0.3 to 0.35 mm, similar to a known nanocable. Alternatively, in view of the greater stiffness and strength of the PBT material it may be preferred to reduce the sheath thickness to less than 0.3 mm, less than 0.25 mm or even less than 0.15 mm or less than 0.12 mm (for example having a thickness like that indicated at 1924′ in FIG. 19).

In versions with more fibres, the additional strength member may be unnecessary to provide adequate stiffness for pushing. For example, a coated fibre bundle of 12 optical fibres is suitable for blowing and for pushing, without having the additional strength member 1926. A 12-fibre example with PBT-based sheath material and 1.8 mm outer diameter Ds has been pushed 100 m through a micro-duct of 6/3.2 mm size.

The above embodiments of the invention can be modified, and/or combined as required for a given commercial application. For example, where the installer needs to use a pullback cable, with a long drop to be installed by pushing, nanocable units 1910 of the type shown in FIG. 19 could be included in the pullback cable. The same units could be useful for example where the drop has exposed sections, not in a micro-duct. For these drops, a nanocable 1910 may be used as a more robust cable than the minimal fibre units 502, 1302, 1302′. Even within the same pullback cable, a mixture of different designs of fibre unit can be deployed: they do not all have to be of one kind or another, just as they can also be a mixture of fibre counts. The exact means of deployment does not have to be known at the time of manufacture.

It goes without saying that all of the above examples also achieve satisfactory optical performance under a range of environmental and mechanical conditions. The optical fibres used in the examples were single mode fibres compliant with G.657.A2 (ITU-T).

### CONCLUSION

While specific embodiments of the present invention have been described above, it will be appreciated that departures from the described embodiments may still fall within the scope of the present invention, defined by the appended claims and their equivalents.

### Additional Disclosure

The present disclosure further includes the following numbered clauses and other statements, based on the claims of the priority application GB 2013892.1.

Clause 1. A fibre optic cable comprising a plurality of retractable fibre units extending in parallel with one another within an extruded polymer tube, the fibre units being free to slide relative to one another and to the tube such that a selected fibre unit can be accessed and re-directed by forming an opening in a wall of the tube and withdrawing a length of the selected fibre unit through the opening, wherein each of said fibre units comprises two or more optical fibres embedded in a solid resin material to form a coated fibre bundle and an extruded polymer sheath covering the coated fibre bundle, wherein the extruded polymer sheath of each said fibre unit comprises primarily polybutylene terephthalate, PBT polymer.

Clause 2. A fibre optic cable according to clause 1 wherein the extruded sheath of each said fibre unit comprises a mixture of PBT polymer and one or more additives including at least one friction reducing material.

Clause 3. A fibre optic cable according to clause 2 wherein said PBT polymer excluding additives comprises at least 95% by weight, at least 90% by weight or at least 80% by weight of the extruded sheath.

Clause 4. A fibre optic cable according to clause 2 or 3 wherein said friction reducing material(s) include a polydimethylsiloxane (PDMS).

The PDMS may be an ultra-high molecular weight PDMS. The carrier material may be for example a polyacrylate, for example a copolymer of ethylene and methyl acrylate (EMA). The carrier material may be for example a polyolefin, such as low-density polyethylene (LPDE). These materials are available for example from Dow Corning in the form of masterbatch additives for leather with the base polymer of the sheath in an extrusion machine.

Clause 5. A fibre optic cable according to clause 2, 3 or 4 wherein the amount of friction reducing additive is between 1% and 5%, optionally between 2% and 4% by weight of the material of the extruded sheath.

The amount of additional friction reducing additive, for example polyacrylate dimethyl siloxane, may be between 1% and 5% by weight of the material of the extruded sheath. The inventors have found that between 2% and 4%, more particularly between 2.5 and 3.5% of a commercially available LDPE-based PDMS additive affords a substantial reduction in friction, with no attendant problems in extrusion. This performance was apparently better than using a polyacrylate based additive specifically markets for blending with PBT.

Clause 6. A fibre optic cable according to any preceding clause wherein an inner surface of the extruded polymer tube of the fibre optic cable has been formed with projections effective to reduce an area of contact between material of the tube and the fibre units.

Clause 7. A fibre optic cable according to any preceding clause wherein the extruded polymer tube comprises a co-extrusion of a lining material within a main tubular body of a different polymer to the lining.

Clause 8. A fibre optic cable according to any preceding clause wherein said extruded polymer tube is extruded with one or more strength members integrated in a main wall of the tube during extrusion.

Clause 9. A fibre optic cable according to any preceding clause wherein, when said fibre optic cable is laid out in a generally straight route, a length of 100 m of a selected fibre unit can be withdrawn through an opening in the extruded tube at a speed greater than 1.4 m/s, without a pulling force exceeding the weight of a mass W, defined as the mass per kilometre length of the selected fibre unit, optionally without exceeding three quarters of the weight of said mass W, or optionally one half or one third of the weight of said mass W.

Clause 10. A fibre optic cable according to any preceding clause wherein, when said fibre optic cable is laid out in a generally straight route, a length of 100 m of a selected fibre unit can reliably be withdrawn through an opening in the extruded tube at a speed of 1.4 m/s, without a pulling force exceeding 5 N multiplied by the number of optical fibres in the selected fibre unit, optionally 2.5 N multiplied by the number of optical fibres in the selected fibre unit.

Clause 11. A fibre optic cable according to any preceding clause wherein, when said fibre optic cable is laid out in a generally straight route, a length of 200 m of a selected fibre unit can be withdrawn through an opening in the extruded tube at a speed of 1.4 m/s, without a pulling force exceeding 5 N multiplied by the number of optical fibres in the selected fibre unit.

Clause 12. A method of manufacturing a fibre optic cable comprising a plurality of fibre units extending in parallel with one another within an extruded polymer tube, the method comprising:
(a) receiving said plurality of fibre units, each fibre unit having been manufactured previously and comprising two or more optical fibres embedded in a solid resin material to form a coated fibre bundle and an extruded polymer sheath covering the coated fibre bundle, the extruded polymer sheath comprising primarily polybutylene terephthalate, PBT polymer;
(b) feeding said plurality of fibre units together as a bundle through a central opening in an extrusion die, while extruding said polymer tube through said die around the bundle;
(c) drawing said polymer tube and bundle through the extrusion die while controlling process parameters to draw and cool the polymer tube to have finished interior and exterior dimensions such that the fibre units remain loose within the extruded tube,
thereby producing said fibre optic cable such that a selected fibre unit can be accessed and re-directed by forming an opening in a wall of the tube and withdrawing a length of the selected fibre unit through the opening.

Clause 13. A method according to clause 12 wherein the extruded sheath of each said fibre unit comprises a mixture of PBT polymer and one or more additives including at least one friction reducing material.

Clause 14. A method according to clause 13 wherein said PBT polymer excluding additives comprises at least 95% by weight, at least 90% by weight or at least 80% by weight of the extruded sheath.

Clause 15. A method according to clause 13 or 14 wherein said friction reducing material(s) include a polydimethylsiloxane, for example a polyacrylate dimethyl siloxane.

Clause 16. A method according to clause 13, 14 or 15 wherein the amount of friction reducing material(s) is between 1% and 5%, optionally between 2% and 4% by weight of the material of the extruded sheath.

Clause 17. A method according to clause 13, 14 or 15 wherein the material of said extruded polymer tube comprises a commercially available PBT loose tube material having friction reducing material therein and one or more additional friction reducing materials.

Clause 18. A method according to any of clauses 12 to 17 wherein a lining of the extruded polymer tube comprises primarily high density polyethylene, HDPE.

Clause 19. A method according to any of clauses 12 to 18 wherein the lining of the extruded polymer tube comprises one or more additives including a friction reducing material.

Clause 20. A method according to any of clauses 12 to 19 wherein an inner surface of the extruded polymer tube of the fibre optic cable is formed with projections effective to reduce an area of contact between material of the tube and the fibre units.

Clause 21. A method according to any of clauses 12 to 20 wherein the solid resin material has a tensile modulus greater than 100 MPa, optionally greater than 300 MPa.

Clause 22. A method according to any of clauses 12 to 21 wherein in step (b) the extruded tube is formed by co-extrusion of a lining material within a main tubular body of a different material to the lining.

Clause 23. A method according to any of clauses 12 to 22 wherein in step (b) said extruded tube is extruded with one or more strength members integrated therein.

Clause 24. A method of providing fibre optic connections from a distribution point to a plurality of customer access points, the method comprising:
(a) installing an optical fibre cable according to any of clauses 1 to 11 extending from the distribution point and past the plurality of customer access points;
(b) for a customer access point, providing an opening in the tube wall of the fibre optic cable at a location convenient for the customer access point and withdrawing a length of a selected fibre unit through the opening;
(c) providing a branching duct from the vicinity of said opening to said customer access point;
(d) installing the withdrawn length of the selected fibre unit through the branching duct from the opening to the access point; and
(e) repeating steps (b) to (d) for successive customer access points, selecting a different fibre unit each time and forming a new opening or re-using an existing opening at a convenient location.

Clause 25. A method according to clause 24 wherein for at least one selected fibre unit the length of fibre unit withdrawn through the opening exceeds 100 m.

Clause 26. A method according to clause 24 wherein for at least one selected fibre unit the length of fibre unit installed through the branching duct exceeds 50 m.

Clause 27. A method according to any of clauses 24 to 26 wherein for at least one customer access point in step (d) the selected fibre unit is installed through the branching duct by pushing.

Clause 28. A method according to any of clauses 24 to 27 wherein for at least one customer access point in step (d) the selected fibre unit is installed through the branching duct by blowing.

1. A fibre optic cable comprising at least one fibre unit wherein said fibre unit comprises two or more optical fibres embedded in a solid resin material to form a coated fibre bundle and an extruded polymer sheath covering the coated fibre bundle, wherein the extruded polymer sheath of each said fibre unit comprises a mixture of polybutylene terephthalate (PBT) polymer, and at least one friction reducing additive.

2. A fibre optic cable as claimed in claim 1 wherein said PBT polymer excluding additives comprises at least 95% by weight, at least 90% by weight or at least 80% by weight of the extruded sheath.

3. A fibre optic cable as claimed in claim 1 wherein said friction reducing additive comprises a polydimethylsiloxane (PDMS) material, in a carrier material.

4. A fibre optic cable as claimed in claim 3 wherein said PDMS is an ultra-high molecular weight PDMS and said carrier material is a polyacrylate material, for example a copolymer of ethylene and methyl acrylate (EMA).

5. A fibre optic cable as claimed in claim 3 wherein said PDMS is an ultra-high molecular weight PDMS and said carrier material is a polyolefin, such as low-density polyethylene (LPDE).

6. A fibre optic cable as claimed in claim 5 wherein additive comprises at least 40% by weight ultra-high molecular weight PDMS and said carrier material is low-density polyethylene (LPDE).

7. A fibre optic cable as claimed in claim 1 wherein the amount of friction reducing additive is between 1% and 5%, optionally between 2% and 4% by weight of the material of the extruded sheath.

8. A fibre optic cable as claimed in claim 1 wherein the solid resin material is a UV-cured resin such as an acrylate material and has a tensile modulus greater than 100 MPa, optionally in the range 250-700 MPa.

9. A fibre optic cable as claimed in claim 1 comprising a plurality of said fibre units extending in parallel with one another and being arranged within an extruded polymer tube, the fibre units being free to slide relative to one another and relative to the tube such that a selected fibre unit can be accessed and re-directed by forming an opening in a wall of the tube and withdrawing a length of the selected fibre unit through the opening.

10. A fibre optic cable as claimed in claim 9 wherein the thickness of the PBT sheath on each fibre unit is between 0.05 mm and 0.25 mm, optionally between 0.15 mm and 0.25 mm.

11. A fibre optic cable as claimed in claim 9 wherein an inner surface of the extruded polymer tube of the fibre optic cable has been formed with projections effective to reduce an area of contact between material of the tube and the fibre units.

12. A fibre optic cable as claimed in claim 9 wherein at least a lining of the extruded polymer tube comprises primarily high density polyethylene (HDPE).

13. A fibre optic cable as claimed in claim 9 wherein said extruded polymer tube is extruded with one or more strength members integrated in a wall of the tube during extrusion.

14. A fibre optic cable as claimed in claim 1 comprising a single fibre unit whose outermost layer is said PBT sheath, fibre optic cable being adapted to be installed in a duct by blowing.

15. A fibre optic cable as claimed in claim 14 wherein a thickness of the PBT sheath on the fibre unit is between 0.05 mm and 0.2 mm, optionally between 0.08 mm and 0.15 mm, optionally less than 0.130 mm.

16. A fibre optic cable as claimed in claim 14 wherein the number of optical fibres including any mechanical fibre is up to four and wherein an outer diameter of the fibre unit is less than 1.2 mm, optionally less than 1.1 mm, or wherein the number of optical fibres including any mechanical fibre is up to 6, 8, 12 or 24 fibres and an outer diameter of the fibre unit is less than 1.3, 1.5, 1.6 and 2.1 mm, respectively.

17. A fibre optic cable as claimed in claim 14 wherein said fibre optic cable is further adapted to be installed by pushing, and wherein an outer diameter of the fibre unit is in the range of 1.2 to 2.5 mm, for example in the range 1.4 to 2.0 mm, for example 1.4 to 1.8 mm.

18. A fibre optic cable as claimed in claim 17 wherein said coated fibre bundle includes one or more strength members, for example an FRP strength member, embedded together with said optical fibres within said resin material.

19. A fibre optic cable as claimed in claim 14 wherein at least one of said optical fibres is terminated at least one end with a blowable optical ferrule prior to installation in a duct.

20. A method of manufacturing a fibre unit for use as a fibre optic cable or for use in the manufacture of a fibre optic cable, the method comprising:
(a) receiving a coated fibre bundle comprising two or more optical fibres embedded. in a solid resin material; and
(b) extruding a polymer sheath covering the coated fibre bundle, the extruded polymer sheath comprising a mixture of polybutylene terephthalate (PBT) polymer and at least one friction reducing additive.

21. A method of manufacturing a fibre optic cable comprising a plurality of fibre units extending in parallel with one another within an extruded polymer tube, the method comprising:
(c) receiving a plurality of fibre units, each fibre unit having been manufactured by the method of claim 20;
(d) feeding said plurality of fibre units together as a bundle through a central opening in an extrusion die, while extruding said polymer tube through said die around the bundle;
(e) drawing said polymer tube and bundle through the extrusion die while controlling process parameters to draw and cool the polymer tube to have finished interior and exterior dimensions such that the fibre units remain loose within the extruded tube,
thereby producing said fibre optic cable such that a selected fibre unit can be accessed and re-directed by forming an opening in a wall of the tube and withdrawing a length of the selected fibre unit through the opening.
